(19) United States
(12) Patent Application Publication
(10) Pub. No.: US 2025/0388743 A1
(43) Pub. Date: Dec. 25, 2025

(54) PROPYLENE-BASED RESIN COMPOSITION AND MOLDED ARTICLE

(71) Applicant: SUMITOMO CHEMICAL COMPANY, LIMITED, Tokyo (JP)

(72) Inventor: Sho KURIMOTO, Chiba (JP)

(21) Appl. No.: 19/239,119

(22) Filed: Jun. 16, 2025

(30) Foreign Application Priority Data
Jun. 24, 2024 (JP) 2024-101370
May 28, 2025 (JP) 2025-088507

(51) Int. Cl. C08L 23/12; B29C 45/00; B29K 23/00; C08K 3/016; C08K 7/14

(52) U.S. Cl. CPC C08L 23/12; B29C 45/0001; C08K 3/016; C08K 7/14; B29K 2023/12

(57) ABSTRACT

Provided are a molded article that has excellent flame retardancy, and even though it contains fibers, can exhibit a small amount of deformation caused by flame contact that can be suppressed to a level comparable to that before deformation, and a propylene-based resin composition capable of producing the molded article. A polypropylene-based resin composition contains a polypropylene-based polymer (A), a flame retardant (B), and fibers (C), in which the fibers (C) include a fiber having a flat cross-sectional shape in which a ratio of a major axis to a minor axis [major axis/minor axis] in a cross section is 2.0 or more, and a molded article contains the polypropylene-based resin composition.

### BACKGROUND OF THE INVENTION

### Field of the Invention

The present invention relates to a propylene-based resin composition and a molded article.

### Description of the Related Art

A polypropylene-based resin has excellent molding processability and the like, and is used for various applications, for example, as materials for interior and exterior members for automobiles. Among the members for automobiles, members required to have flame retardancy have been conventionally formed using a metal as a material, but in recent years, for these members, replacement with a molded article of a resin composition has also been studied for the purpose of weight reduction. A molded article of a resin composition that substitutes a metal member is required to have rigidity in addition to flame retardancy. As a resin composition exhibiting such characteristics, a polyolefin-based resin composition having flame retardancy has attracted attention, and for example, a polypropylene-based resin composition containing a polypropylene-based polymer (A), a flame retardant (B), and glass fibers (C) having an aspect ratio of 20 to 60 has been proposed (WO 2022/030480).

### SUMMARY OF THE INVENTION

In general, in a molded article formed of a resin composition containing (reinforced) fibers such as glass fibers, anisotropy is likely to occur in the arrangement of the fibers during molding, and rigidity and deformability are not uniform due to the arrangement anisotropy of the fibers. In addition, when the molded article exhibiting flame retardancy is exposed to flame, in addition to softening of the resin as a base material, a temporal change including chemical changes such as thermal decomposition of the resin (molecular weight reduction) and flame retardant action of the flame retardant (for example, formation of a carbonized foam layer) occurs. As the temporal change progresses, so-called “melt sagging” in which the vicinity of the flame contact portion of the molded article melts and sags is induced. At this time, in the resin composition containing fibers, the amount of deformation caused by flame contact, that is, the melt sagging amount becomes uneven in the vicinity of the flame-contacted portion.

An object of the present invention is to provide a molded article that has excellent flame retardancy, and even though it contains fibers, can exhibit a small amount of deformation caused by flame contact that can be suppressed to a level comparable to that before deformation, and a propylene-based resin composition capable of producing the molded article.

As a result of intensive studies to solving the above problems, the present inventors have found that, by using, as fibers to be contained in a propylene-based resin composition, fibers having a flat cross-sectional shape with a ratio of major axis to minor axis [major axis/minor axis] of 2.0 or more in a cross section, instead of the fibers having a circular cross-section that have been commonly used in the related art, the overall amount of deformation is small and can be suppressed to a level comparable to that before deformation, even when arrangement anisotropy of the fibers occurs in the molded article, without impairing excellent flame retardancy, and even when melt sagging occurs due to deformation caused by flame contact. The present invention has been completed through further studies based on these findings.

That is, the object of the present invention has been achieved by the following.

[1] A polypropylene-based resin composition containing a polypropylene-based polymer (A), a flame retardant (B), and fibers (C),
in which the fibers (C) include a fiber having a flat cross-sectional shape in which a ratio of a major axis to a minor axis [major axis/minor axis] in a cross section is 2.0 or more.
   [2] The polypropylene-based resin composition according to [1], in which the fibers (C) are glass fibers.
   [3] The polypropylene-based resin composition according to [1] or [2], in which the fibers (C) are glass fiber chopped strands.
   [4] The polypropylene-based resin composition according to any one of [1] to [3], in which a weight average fiber length of the fibers (C) is 200 to 800 μm.
   [5] The polypropylene-based resin composition according to any one of [1] to [4], in which the flame retardant (B) includes a phosphorus-containing flame retardant.
   [6] The polypropylene-based resin composition according to any one of [1] to [5], in which the flame retardant (B) includes an intumescent flame retardant.
   [7] The polypropylene-based resin composition according to any one of [1] to [6], in which when a total amount of the polypropylene-based resin composition is 100 mass %,
a content of the polypropylene-based polymer (A) is 25 to 70 mass %,
a content of the flame retardant (B) is 5 to 50 mass %, and
a content of the fibers (C) is 5 to 50 mass %.
   [8] The polypropylene-based resin composition according to any one of [1] to [7], further containing an acid-modified polyolefin-based polymer (D).
   [9] The polypropylene-based resin composition according to [8], in which when a total amount of the polypropylene-based resin composition is 100 mass %,
a content of the acid-modified polyolefin-based polymer (D) is 0.1 to 5.0 mass %.
   [10] A molded article containing the polypropylene-based resin composition according to any one of [1] to [9].
   [11] An injection molded article containing the polypropylene-based resin composition according to any one of [1] to [9].

The present invention can provide a molded article that has excellent flame retardancy, and even though it contains fibers, can exhibit a small amount of deformation caused by flame contact that can be suppressed to a level comparable to that before deformation, and a propylene-based resin composition capable of producing the molded article.

### DETAILED DESCRIPTION OF THE PREFERRED EMBODIMENTS

Hereinafter, the present invention will be specifically described. The present invention is not limited to the specific embodiments shown below.

### Description of Terms

In describing the present invention, first, terms commonly used will be described.

In the present invention and the present specification, the “monomer unit” means a structural unit (residue) derived from a monomer contained in a polymer obtained by polymerizing a monomer.

In the present invention and the present specification, the “α-olefin” means an olefin having a carbon-carbon double bond at the terminal (α-position).

In the present invention and the present specification, a binding mode (arrangement of structural units) of two or more types of structural units in the copolymer to be a resin or an elastomer is not particularly limited, and may be, for example, any binding mode such as a random bond (random copolymer), a block bond (block copolymer), an alternating bond (alternating copolymer), or a graft bond (graft copolymer) unless otherwise specified.

In the present invention and the present specification, unless otherwise specified, “%” means mass %, and “part(s)” means “part(s) by mass”.

In the present invention and the present specification, in a case where the content, physical properties, and the like are described by showing numerical ranges, when an upper limit value and a lower limit value of the numerical range are separately described, any of the upper limit value and the lower limit value can be appropriately combined to set a specific numerical range. On the other hand, when a plurality of numerical ranges represented by “to” are set and described, the upper limit value and the lower limit value forming the numerical range are not limited to the specific combination described before and after “to” as the specific numerical range, and may be in a numerical range in which the upper limit value and the lower limit value of each numerical range are appropriately combined. Note that, in the present invention and the present specification, a numerical range represented by “to” means a range including numerical values described before and after “to” as a lower limit value and an upper limit value.

In the present invention and the present specification, the “melt flow rate (MFR)” means a “melt mass flow rate”, and is a melt flow rate (unit: g/10 min) measured in accordance with JIS K 7210-1:2014 and JIS K 7210-2:2014 under conditions of a temperature of 230° C. and a load of 2.16 kgf, unless otherwise specified.

In the present invention and the present specification, the “limiting viscosity (unit: dL/g)” is a value measured at a temperature of 135° C. using tetralin as a solvent by the following method.

Using an Ubbelohde viscometer, a reduced viscosity is measured for a plurality of concentrations, the reduced viscosity is plotted with respect to the concentration, and the limiting viscosity is determined by an “extrapolation method” in which the concentration is extrapolated to zero. More specifically, the limiting viscosity is determined by a method of measuring a reduced viscosity at three points of concentrations of 0.1 g/dL, 0.2 g/dL and 0.5 g/dL, plotting the reduced viscosity with respect to the concentration, and extrapolating the concentration to zero, using the method described on page 491 of “Polymer solution, Polymer Experiment 11” (published by KYORITSU SHUPPAN CO., LTD., 1982).

### [[Polypropylene-Based Resin Composition]]

A polypropylene-based resin composition of the present invention contains a polypropylene-based polymer (A), a flame retardant (B), and fibers (C). The fibers (C) include a fiber having a flat cross-sectional shape in which a ratio of a major axis to a minor axis [major axis/minor axis] in a cross section is 2.0 or more.

The polypropylene-based resin composition of the present invention containing the fiber having a flat cross-sectional shape (hereinafter, may be referred to as “flat fiber”) as the fiber (C) exhibits excellent flame retardancy. In addition, the polypropylene-based resin composition of the present invention can suppress softening and melting in the vicinity of a flame contact portion even when exposed to flame, and can suppress the amount of deformation (melt sagging amount) to be small and a level comparable to that before deformation when formed into a molded article. In particular, the polypropylene-based resin composition of the present invention can effectively suppress the amount of deformation even in a transverse direction (TD) in which deformation is likely to occur due to the arrangement anisotropy of the fibers (C) when a molded article is formed by an injection molding method. As a result, it is possible to reduce a difference from the amount of deformation in a machine direction (MD), and to realize an injection molded article capable of suppressing the amount of deformation in the TD and the MD to a level comparable to that before deformation.

In addition, the polypropylene-based resin composition of the present invention can suppress, in addition to the amount of deformation caused by flame contact, preferably non-uniformity of the amount of deformation of a molded article caused by arrangement anisotropy generally generated in a molded article containing fibers, and can also suppress the overall amount of deformation to a level comparable to that before deformation (exhibit high rigidity). In particular, the polypropylene-based resin composition of the present invention can effectively suppress the amount of deformation also in the TD to reduce the difference from the amount of deformation in the MD, and can realize an injection molded article capable of suppressing the amount of deformation caused by arrangement anisotropy in the TD and the MD to a level comparable to that before deformation.

Note that the molded article formed of the polypropylene-based resin composition of the present invention is usually hardly deformed, and the amount of deformation is highly suppressed regardless of the arrangement direction of the fibers (C).

First, components contained in the polypropylene-based resin composition of the present invention will be described.

Each component contained in the polypropylene-based resin composition of the present invention may be one type or two or more types.

### [Polypropylene-Based Polymer (A)]

The polypropylene-based polymer (A) refers to a polymer containing a propylene-derived unit (also referred to as “propylene unit”) in an amount of more than 50 mass % with respect to the amount of all structural units (100 mass %) of the polymer. The propylene unit in the polypropylene-based polymer (A) is usually 100 mass % or less.

Examples of the polypropylene-based polymer include a propylene homopolymer and a copolymer obtained by polymerizing propylene and one or more other monomers that can be copolymerized with the propylene in an arbitrary ratio combination. The copolymer may be a random copolymer or a block copolymer.

The polypropylene-based resin composition may contain one type of polypropylene-based polymer as the polypropylene-based polymer (A), or may contain a combination of two or more types of polypropylene-based polymers in an arbitrary ratio.

Examples of the one type of polypropylene-based polymer include a homopolymer of propylene and a random copolymer of propylene and one or more types of other monomers copolymerizable therewith (for example, ethylene or an α-olefin having 4 or more carbon atoms) (hereinafter, also referred to as a polypropylene-based random copolymer).

Examples of the combination of two or more types of polypropylene-based polymers include a combination of two or more types of propylene homopolymers having different weight average molecular weights and the like, and a combination of the following polymer (I) and polymer (II).

The polypropylene-based resin composition may contain a heterophasic propylene polymerization material as the polypropylene-based polymer. Here, the “heterophasic propylene polymerization material” means a material containing two or more types of polypropylene-based polymers, in which the two or more types of polypropylene-based polymers are incompatible and form different phases.

Examples of the heterophasic propylene polymerization material include a combination of the following polymer (I) and polymer (II). Here, the polymer (I) is a polymer containing a propylene unit in an amount of more than 80 mass % and 100 mass % or less with respect to the amount of all structural units, and may be a propylene homopolymer or a copolymer of propylene and the other monomer. The polymer (II) is a copolymer of a propylene unit and at least one monomer unit selected from the group consisting of an ethylene unit and an α-olefin unit having 4 or more carbon atoms. Each of the polymer (I) and the polymer (II) may be one type of polymer or a combination of two or more types of polymers.

The polypropylene-based polymer is preferably one or more selected from the group consisting of a propylene homopolymer and a heterophasic propylene polymerization material, and more preferably a propylene homopolymer, from the viewpoint of improving the rigidity and impact resistance of the molded article.

In the present invention, a polystyrene-equivalent weight average molecular weight of the polypropylene-based polymer (A) is usually 1,000 to 1,000,000 and preferably 5,000 to 1,000,000, from the viewpoint of improving the appearance and elongation properties of the molded article.

From the viewpoint of improving the rigidity of the molded article, the isotactic pentad fraction (also referred to as [mmmm] fraction) of the polypropylene-based polymer is preferably 0.96 or more, more preferably 0.97 or more as measured by ¹³C-NMR. The closer the isotactic pentad fraction of the polypropylene-based polymer is to 1, the higher the stereoregularity of the molecular structure of the polypropylene-based polymer is, and the higher the crystallinity of the polypropylene-based polymer is. When the polypropylene-based polymer is a copolymer, the isotactic pentad fraction can be measured for the chain of the propylene unit in the copolymer.

From the viewpoint of improving the molding processability of the polypropylene-based resin composition of the present invention, a melt flow rate (MFR) of the polypropylene-based polymer is preferably 1 g/10 min or more and more preferably 10 g/10 min or more, and is preferably 500 g/10 min or less and more preferably 10 to 300 g/10 min.

The polypropylene-based polymer can be produced, for example, by the following polymerization method using a polymerization catalyst.

Examples of the polymerization catalyst include a Ziegler catalyst system, a Ziegler-Natta catalyst system, a catalyst system containing a cyclopentadienyl ring-containing transition metal compound of Group 4 in the periodic table and alkylaluminoxane, a catalyst system containing a cyclopentadienyl ring-containing transition metal compound of Group 4 in the periodic table, a compound that forms an ionic complex by reacting with the cyclopentadienyl ring-containing transition metal compound, and an organoaluminum compound, and a catalyst system in which a catalyst component (for example, a cyclopentadienyl ring-containing transition metal compound of Group 4 in the periodic table, a compound that forms an ionic complex, an organoaluminum compound, and the like) is supported on inorganic particles (for example, silica, clay minerals, and the like) and modified. In addition, a preliminary polymerization catalyst prepared by preliminarily polymerizing monomers such as ethylene or α-olefins in the presence of such a catalyst system may be used. Examples of the Ziegler-Natta catalyst system include a catalyst system using a titanium-containing solid transition metal component and an organometallic component in combination.

Examples of such a catalyst system include catalyst systems described in JP-A-61-218606, JP-A-5-194685, JP-A-7-216017, JP-A-9-316147, JP-A-10-212319, and JP-A-2004-182981. In the present specification, the contents described in the above patent documents can be referred to as appropriate, and the contents are incorporated as a part of the description of the present specification as they are.

Examples of the polymerization method include bulk polymerization, solution polymerization (liquid phase polymerization), and gas phase polymerization. Here, the bulk polymerization refers to a method in which polymerization is performed using a liquid olefin as a medium at a polymerization temperature. The solution polymerization refers to a method in which polymerization is performed in an inert hydrocarbon solvent such as propane, butane, isobutane, pentane, hexane, heptane, or octane. The gas phase polymerization method refers to a method in which a gaseous monomer is used as a medium and a gaseous monomer is polymerized in the medium.

In performing the polymerization method, examples of the polymerization manner include a batch type, a continuous type, and a combination thereof. The polymerization manner may be a multistage manner performed using a plurality of polymerization reaction tanks connected in series.

Various conditions (polymerization temperature, polymerization pressure, monomer concentration, catalyst loading amount, polymerization time, and the like) in the polymerization method can be appropriately determined according to the target polypropylene-based polymer.

In the production of the polypropylene-based polymer, in order to remove a residual solvent contained in the resulting polypropylene-based polymer, an ultra-low molecular weight oligomer by-produced during the production, and the like, the resulting polypropylene-based polymer may be held at a temperature at which impurities such as the residual solvent and the oligomer can volatilize, and which is lower than a temperature at which the polypropylene-based polymer melts. Examples of the method for removing impurities such as a residual solvent and an oligomer include methods described in JP-A-55-75410 and JP 2565753, and in the present specification, the contents described in these patent documents can be appropriately referred to, and the contents are incorporated as a part of the description of the present specification as they are.

### <Propylene Homopolymer>

A limiting viscosity [η] of the propylene homopolymer is preferably 0.1 to 2 dL/g, more preferably 0.5 to 1.5 dL/g, and still more preferably 0.7 to 1.4 dL/g, from the viewpoint of improving the fluidity during melting of the polypropylene-based resin composition of the present invention and the toughness of the molded article containing the polypropylene-based resin composition.

A molecular weight distribution Mw/Mn of the propylene homopolymer is preferably 3 or more and less than 7, and more preferably 3 to 5, from the viewpoint of improving the fluidity of the polypropylene-based resin composition of the present invention during melting and the toughness of the molded article containing the polypropylene-based resin composition of the present invention. Here, Mw represents a weight average molecular weight, and Mn represents a number average molecular weight. The molecular weight distribution is a numerical value measured by gel permeation chromatography (also referred to as GPC).

### <Polypropylene-Based Random Copolymer>

Examples of the polypropylene-based random copolymer include a random copolymer containing a propylene unit and a unit derived from ethylene (also referred to as “ethylene unit”) (hereinafter, also referred to as “random copolymer (1)”), a random copolymer containing a propylene unit and a unit derived from an α-olefin having 4 or more carbon atoms (hereinafter, also referred to as “olefin unit”) (hereinafter, also referred to as “random polymer (2)”), and a random copolymer containing a propylene unit, an ethylene unit, and an olefin unit (hereinafter, also referred to as “random polymer (3)”).

The α-olefin having 4 or more carbon atoms that can constitute the polypropylene-based random copolymer may be a linear olefin, a branched olefin, or a cyclic olefin. The α-olefin is preferably an α-olefin having 4 to 10 carbon atoms. Examples of the α-olefin having 4 to 10 carbon atoms include 1-butene, 1-pentene, 1-hexene, 4-methyl-1-pentene, 1-octene, and 1-decene, and 1-butene, 1-hexene, and 1-octene are preferable. Examples of the cyclic olefin include vinylcyclopropane and vinylcyclobutane.

Examples of the random copolymer (2) include a propylene-1-butene random copolymer, a propylene-1-hexene random copolymer, a propylene-1-octene random copolymer, and a propylene-1-decene random copolymer.

Examples of the random copolymer (3) include a propylene-ethylene-1-butene copolymer, a propylene-ethylene-1-hexene copolymer, a propylene-ethylene-1-octene copolymer, and a propylene-ethylene-1-decene copolymer.

A content of the ethylene unit in the random copolymer (1) is not particularly limited, and is preferably 0.1 to 40 mass %, more preferably 0.1 to 30 mass %, and still more preferably 2 to 15 mass %.

A content of the olefin unit in the random copolymer (2) is not particularly limited, and is preferably 0.1 to 40 mass %, more preferably 0.1 to 30 mass %, and still more preferably 2 to 15 mass %.

A total content of the ethylene unit and the olefin unit in the random copolymer (3) is not particularly limited, and is preferably 0.1 to 40 mass %, more preferably 0.1 to 30 mass %, and still more preferably 2 to 15 mass %.

A content of the propylene unit in each of the random copolymers (1) to (3) is not particularly limited, and is preferably 60 to 99.9 mass %, more preferably 70 to 99.9 mass %, and still more preferably 85 to 98 mass %.

### <Heterophasic Propylene Polymerization Material>

As described above, the polymer (I) is a polymer containing a propylene unit in an amount of more than 80 mass % and 100 mass % or less with respect to the amount of all structural units. A total content of the monomer units other than the propylene unit in the polymer (I) is usually 0 mass % or more and less than 20 mass %, and may be 0 mass % or 0.01 mass % or more, with respect to 100 mass % of the polymer (I).

Examples of the monomer unit other than the propylene unit that may be contained in the polymer (I) include an ethylene unit and an α-olefin unit having 4 or more carbon atoms.

The α-olefin having 4 or more carbon atoms that can constitute the polymer (I) may be a linear olefin, a branched olefin, or a cyclic olefin. The α-olefin is the same as the α-olefin having 4 or more carbon atoms in the polypropylene-based random copolymer, preferably an α-olefin having 4 to 10 carbon atoms, more preferably 1-butene, 1-hexene, 1-octene, or 1-decene, and still more preferably 1-butene.

Examples of the polymer (I) include a propylene homopolymer, a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer.

Among them, the polymer (I) is preferably a propylene homopolymer, a propylene-ethylene copolymer, a propylene-1-butene copolymer, or a propylene-ethylene-1-butene copolymer, and is particularly preferably a propylene homopolymer from the viewpoint of the rigidity of a molded article containing the polypropylene-based resin composition of the present invention.

As described above, the polymer (II) is a copolymer of a propylene unit and at least one type of another monomer unit selected from the group consisting of an ethylene unit and an α-olefin unit having 4 or more carbon atoms.

The polymer (II) is preferably a polymer containing a propylene unit in an amount of more than 0 mass % and 90 mass % or less, and more preferably a polymer containing a propylene unit in an amount of more than 0 mass % and 80 mass % or less, with respect to the mass of all structural units. The polymer (II) may also be a random copolymer or a block copolymer.

A total content of the ethylene unit and the α-olefin unit having 4 or more carbon atoms in the polymer (II) is preferably 20 to 80 mass % and more preferably 20 to 60 mass % with respect to 100 mass % of the polymer (II).

The α-olefin having 4 or more carbon atoms that can constitute the polymer (II) is preferably an α-olefin having 4 to 10 carbon atoms, and is the same as the α-olefin that can constitute the polymer (I).

Examples of the polymer (II) include a propylene-ethylene copolymer, a propylene-ethylene-1-butene copolymer, a propylene-ethylene-1-hexene copolymer, a propylene-ethylene-1-octene copolymer, a propylene-ethylene-1-decene copolymer, a propylene-1-butene copolymer, a propylene-1-hexene copolymer, a propylene-1-octene copolymer, and a propylene-1-decene copolymer. The polymer (II) is preferably a propylene-ethylene copolymer, a propylene-1-butene copolymer, or a propylene-ethylene-1-butene copolymer, and more preferably a propylene-ethylene copolymer.

A content of the polymer (II) in the heterophasic propylene polymerization material is not particularly limited, and is preferably 1 to 50 mass %, more preferably 1 to 40 mass %, still more preferably 5 to 30 mass %, and particularly preferably 8 to 15 mass %, with respect to 100 mass % of the total mass of the polymer (I) and the polymer (II).

In the heterophasic propylene polymer material, the combination of polymer (I) and polymer (II) is not particularly limited, and any suitable combination of polymers may be used. Preferably, a combination of a preferred polymer (I) and a preferred polymer (II) is used.

Examples of the heterophasic propylene polymerization material include combinations of the following polymers in which the polymer (I) is a propylene homopolymer:
a combination of a propylene homopolymer and a (propylene-ethylene) copolymer, a combination of a propylene homopolymer and a (propylene-ethylene-1-butene) copolymer, a combination of a propylene homopolymer and a (propylene-ethylene-1-hexene) copolymer, a combination of a propylene homopolymer and a (propylene-ethylene-1-octene) copolymer, a combination of a propylene homopolymer and a (propylene-1-butene) copolymer, a combination of a propylene homopolymer and a (propylene-1-hexene) copolymer, a combination of a propylene homopolymer and a (propylene-1-octene) copolymer, and a combination of a propylene homopolymer and a (propylene-1-decene) copolymer.

Examples of the heterophasic propylene polymerization material include a combination of the following polymers in which the polymer (I) is a polymer containing a propylene unit and another monomer unit other than the propylene unit. Here, the type of the polymer (I) is described first, and the type of the polymer (II) is described below.

Examples of the combination of the polymers include a combination of a (propylene-ethylene) copolymer and a (propylene-ethylene) copolymer, a combination of a (propylene-ethylene) copolymer and a (propylene-ethylene-1-butene) copolymer, a combination of a (propylene-ethylene) copolymer and a (propylene-ethylene-1-hexene) copolymer, a combination of a (propylene-ethylene) copolymer and a (propylene-ethylene-1-octene) copolymer, a combination of a (propylene-ethylene) copolymer and a (propylene-ethylene-1-decene) copolymer, a combination of a (propylene-ethylene) copolymer and a (propylene-1-butene) copolymer, a combination of a (propylene-ethylene) copolymer and a (propylene-1-hexene) copolymer, a combination of a (propylene-ethylene) copolymer and a (propylene-1-octene) copolymer, a combination of a (propylene-ethylene) copolymer and a (propylene-1-decene) copolymer, a combination of a (propylene-1-butene) copolymer and a (propylene-ethylene) copolymer, a combination of a (propylene-1-butene) copolymer and a (propylene-ethylene-1-butene) copolymer, a combination of a (propylene-1-butene) copolymer and a (propylene-ethylene-1-hexene) copolymer, a combination of a (propylene-1-butene) copolymer and a (propylene-ethylene-1-octene) copolymer, a combination of a (propylene-1-butene) copolymer and a (propylene-ethylene-1-decene) copolymer, a combination of a (propylene-1-butene) copolymer and a (propylene-1-butene) copolymer, a combination of a (propylene-1-butene) copolymer and a (propylene-1-hexene) copolymer, a combination of a (propylene-1-butene) copolymer and a (propylene-1-octene) copolymer, a combination of a (propylene-1-butene) copolymer and a (propylene-1-decene) copolymer, a combination of a (propylene-1-hexene) copolymer and a (propylene-1-hexene) copolymer, a combination of a (propylene-1-hexene) copolymer and a (propylene-1-octene) copolymer, a combination of a (propylene-1-hexene) copolymer and a (propylene-1-decene) copolymer, a combination of a (propylene-1-octene) copolymer and a (propylene-1-octene) copolymer, and a combination of a (propylene-1-octene) copolymer and a (propylene-1-decene) copolymer.

The heterophasic propylene polymerization material that can be contained in the polypropylene-based resin composition of the present invention is preferably a combination of a propylene homopolymer and a (propylene-ethylene) copolymer, a combination of a propylene homopolymer and a (propylene-ethylene-1-butene) copolymer, a combination of a (propylene-ethylene) copolymer and a (propylene-ethylene) copolymer, a combination of a (propylene-ethylene) copolymer and a (propylene-ethylene-1-butene) copolymer, or a combination of a (propylene-1-butene) copolymer and a (propylene-1-butene) copolymer, and more preferably a combination of a propylene homopolymer and a (propylene-ethylene) copolymer.

The heterophasic propylene polymerization material can be produced by multistage polymerization including a preceding polymerization step of producing a polymer (I) and a subsequent polymerization step of producing a polymer (II) in the presence of the polymer (I) produced in the preceding step. The polymerization can be performed using the catalyst system exemplified as the catalyst usable for the production of the polypropylene-based polymer.

A limiting viscosity of the polymer (I) (hereinafter, referred to as [η]I) is preferably 0.1 to 2 dL/g, more preferably 0.5 to 1.5 dL/g, and still more preferably 0.7 to 1.3 dL/g.

A limiting viscosity of the polymer (II) (hereinafter, referred to as [η]II) is preferably 1 to 10 dL/g, more preferably 2 to 10 dL/g, and still more preferably 5 to 8 dL/g.

In addition, a ratio of [η]II to [η]I ([η]II/[η]I) is preferably 1 to 20, more preferably 2 to 10, and still more preferably 2 to 9.

When the polypropylene-based polymer is a polymerization material composed of the polymer (I) and the polymer (II) that are formed by multistage polymerization, a part of the polymer formed by the polymerization in the preceding step is extracted from the polymerization tank to obtain a limiting viscosity, the limiting viscosity of the polymerization material finally obtained by multistage polymerization (hereinafter, denoted as [η]Total) is obtained, and the limiting viscosity of the polymer formed by the polymerization in the subsequent step can be calculated using these values of the limiting viscosity and the content of each polymer.

In addition, when the polymerization material composed of the polymer (I) and the polymer (II) is a material produced by a method in which the polymer (I) is obtained in the preceding polymerization step and the polymer (II) is obtained in the subsequent polymerization step, the procedure for measuring and calculating the content of each of the polymer (I) and the polymer (II) and the limiting viscosities ([η]Total, [η]I, and [η]II) is as follows.

From the limiting viscosity ([η]I) of the polymer (I) obtained in the preceding polymerization step, the limiting viscosity ([η]Total) of the final polymer (that is, the polymerization material composed of the polymer (I) and the polymer (II)) after the subsequent polymerization step measured by the above method, and the content of the polymer (II) contained in the final polymer, the limiting viscosity [η]II of the polymer (II) can be calculated by the following equation.

$$[ η ] II = ( [ η ] Total - [ η ] I \times XI ) / XII$$

In the above equation,
[η]Total is a limiting viscosity of the final polymer (unit: dL/g),
[η]I is a limiting viscosity of the polymer (I) (unit: dL/g),
XI is a mass ratio of the polymer (I) to the final polymer, and
XII is a mass ratio of the polymer (II) to the final polymer.

Note that XI and XII can be determined from the mass balance during polymerization.

The mass ratio XII of the polymer (II) to the final polymer may be calculated from the following equation using a heat of fusion of crystals of each of the polymer (I) and the final polymer.

$$XII = 1 - ( Δ Hf ) T / ( Δ Hf ) P$$

In the above equation,
(ΔHf)T is a heat of fusion of the final polymer (the polymer (I) and the polymer (II)) (unit: cal/g), and
(ΔHf)P is a heat of fusion of the polymer (I) (unit: cal/g).

In addition, the molecular weight distribution (Mw/Mn) of the polymer (I) measured by GPC is preferably 3 or more and less than 7, and more preferably 3 to 5.

The polypropylene-based polymer (A) used in the present invention may contain one or more types of biomass-derived monomers. The same type of monomer constituting the polymer may be only a biomass-derived monomer, or may contain both a biomass-derived monomer and a fossil fuel-derived monomer. The biomass-derived monomer is a monomer obtained by using any renewable natural raw material such as plant-derived or animal-derived including fungi, yeast, algae, and bacteria and a residue thereof as raw materials, contains ¹⁴C isotope as carbon at a ratio of about 10⁻¹², and has a biomass carbon concentration (pMC) measured according to ASTM D 6866 of about 100 (pMC). The biomass-derived monomer is obtained by a conventionally known method. It is preferable that the polypropylene-based polymer (A) used in the present invention contains a biomass-derived monomer from the viewpoint of reducing the environmental load. As long as polymer production conditions such as a polymerization catalyst and a polymerization temperature are equivalent, even when the raw material olefin contains a biomass-derived olefin, the molecular structure other than that containing a ¹⁴C isotope at a ratio of about 10⁻¹² is equivalent to that of a polypropylene-based polymer composed of a fossil fuel-derived monomer. Therefore, it is assumed that the performance does not change.

In addition, the polypropylene-based polymer (A) according to the present invention may contain a chemical recycle-derived monomer. The propylene constituting the polymer may be only a chemical recycle-derived monomer, or may contain a chemical recycle-derived monomer, a fossil fuel-derived monomer, and/or a biomass-derived monomer. The chemical recycle-derived monomer is obtained by a conventionally known method. It is preferable that the polypropylene-based polymer (A) according to the present invention contains a chemical recycle-derived monomer from the viewpoint of environmental load reduction (mainly, waste reduction). Even when the raw material monomer contains a chemical recycle-derived monomer, the chemical recycle-derived monomer is a monomer obtained by returning a polymer such as waste plastic to a monomer unit such as propylene by depolymerization, thermal decomposition, or the like, and a monomer produced using the monomer as a raw material. Therefore, when polymer production conditions such as a polymerization catalyst, a polymerization process, and a polymerization temperature are equivalent, the molecular structure is equivalent to that of a polypropylene-based polymer composed of a fossil fuel-derived monomer. Therefore, it is assumed that the performance does not change.

The polypropylene-based polymer (A) may be modified, and is preferably an unmodified polypropylene-based polymer that is not modified with at least an unsaturated carboxylic acid and an unsaturated carboxylic acid derivative. The unsaturated carboxylic acid and the unsaturated carboxylic acid derivative are the same as those described in the acid-modified polyolefin-based polymer (D). In the present invention, the polypropylene-based polymer (A) being unmodified is not limited to an aspect in which a total content of an unsaturated carboxylic acid unit and an unsaturated carboxylic acid derivative unit in 100 mass % of the polypropylene-based polymer (A) is 0 mass %, and includes an aspect in which the total content is more than 0 mass % and less than 0.1 mass %.

### <Content of Polypropylene-Based Polymer (A)>

A content of the polypropylene-based polymer (A) in the polypropylene-based resin composition is preferably 25 mass % or more, more preferably 30 mass % or more, and still more preferably 35 mass % or more, and is preferably 70 mass % or less, more preferably 65 mass % or less, and still more preferably 60 mass % or less, with respect to 100 mass % of the total amount of the polypropylene-based resin composition.

### [Flame Retardant (B)]

The polypropylene-based resin composition of the present invention contains a flame retardant (B). The polypropylene-based resin composition of the present invention may contain one type of flame retardant, or may contain a combination of two or more types of flame retardants in an arbitrary ratio.

Examples of the flame retardant include a halogen-based flame retardant, a guanidine-based flame retardant, a phosphorus-containing flame retardant, a metal oxide, and a polyvalent hydroxyl group-containing compound, and a phosphorus-containing flame retardant is preferable.

Examples of the halogen-based flame retardant include organic halogenated aromatic compounds. Examples of the organic halogenated aromatic compound include a halogenated diphenyl compound, a halogenated bisphenol-based compound, a halogenated bisphenol bis(alkyl ether)-based compound, and a halogenated phthalimide-based compound.

Examples of the halogenated diphenyl compound include a halogenated diphenyl ether-based compound, a halogenated diphenyl ketone-based compound, and a halogenated diphenyl alkane-based compound.

Examples of the halogenated bisphenol-based compound include a halogenated bisphenyl alkane, a halogenated bisphenyl ether, a halogenated bisphenyl thioether, and a halogenated bisphenyl sulfone.

Examples of the halogenated bisphenol bis(alkyl ether)-based compound include brominated bisphenol A (brominated aliphatic ether), brominated bisphenol S (brominated aliphatic ether), chlorinated bisphenol A (chlorinated aliphatic ether), and chlorinated bisphenol S (chlorinated aliphatic ether), and further include etherified tetrabromobisphenol A and etherified tetrabromobisphenol S.

Examples of the guanidine-based flame retardant include guanidine compounds such as guanidine nitride.

The phosphorus-containing flame retardant is a flame retardant containing a phosphorus atom. The polypropylene-based resin composition of the present invention preferably contains a phosphorus-containing flame retardant. The polypropylene-based resin composition of the present invention may contain one type of phosphorus-containing flame retardant, or may contain a combination of two or more types of phosphorus-containing flame retardants in an arbitrary ratio.

Examples of the phosphorus-containing flame retardant include phosphate, polyphosphate, and phosphoric acid ester.

Examples of the phosphate include melamine orthophosphate, piperazine orthophosphate, melamine pyrophosphate, piperazine pyrophosphate, calcium phosphate, and magnesium phosphate. Specific examples of the polyphosphate include ammonium polyphosphate, piperazine polyphosphate, and melamine polyphosphate.

Examples of the phosphate and polyphosphate include salts of orthophosphoric acid and the following bases, salts of pyrophosphoric acid and the following bases, and salts of polyphosphoric acid and the following bases.

Examples of the base that can be contained in the phosphate include N,N,N′,N′-tetramethyldiaminomethane, ethylenediamine, N,N′-dimethylethylenediamine, N,N′-diethylethylenediamine, N,N-dimethylethylenediamine, N,N-diethylethylenediamine, N,N,N′,N′-tetramethylethylenediamine, N,N′-diethylethylenediamine, 1,2-propanediamine, 1,3-propanediamine, tetramethylenediamine, pentamethylenediamine, hexamethylenediamine, 1,7-diaminoheptane, 1,8-diaminooctane, 1,9-diaminononane, 1,10-diaminodecane, trans-2,5-dimethylpiperazine, 1,4-bis(2-aminoethyl)piperazine, 1,4-bis(3-aminopropyl)piperazine, acetoguanamine, benzoguanamine, acrylguanamine, 2,4-diamino-6-nonyl-1,3,5-triazine, 2,4-diamino-6-hydroxy-1,3,5-triazine, 2-amino-4,6-dihydroxy-1,3,5-triazine, 2,4-diamino-6-methoxy-1,3,5-triazine, 2,4-diamino-6-ethoxy-1,3,5-triazine, 2,4-diamino-6-propoxy-1,3,5-triazine, 2,4-diamino-6-isopropoxy-1,3,5-triazine, 2,4-diamino-6-mercapto-1,3,5-triazine, 2-amino-4,6-dimercapto-1,3,5-triazine, ammeline, phthalodiguanamine, melamine cyanurate, butylenediguanamine, norbornenediguanamine, methylenediguanamine, ethylenedimelamine, trimethylenedimelamine, tetramethylenedimelamine, hexamethylenedimelamine, and 1,3-hexylenedimelamine.

The phosphorus-containing flame retardant is preferably one or more selected from the group consisting of melamine pyrophosphate, piperazine pyrophosphate, and ammonium polyphosphate.

In the present invention, among the phosphorus-containing flame retardants, an intumescent flame retardant is preferable. The intumescent flame retardant refers to a substance that contains phosphorus and nitrogen in its constituent components and can impart flame retardancy to a molded article containing the intumescent flame retardant. In the molded article containing the intumescent flame retardant, when the molded article is combusted, the molded article is heated by combustion to form a foam expansion layer formed of a foam-like coating on the surface, such that high flame retardancy can be exhibited. It can be said that the intumescent flame retardant is a substance having an action of forming a foam expansion layer formed of a foam-like coating at the time of combustion of a molded article containing the intumescent flame retardant.

The intumescent flame retardant may be a compound containing both a phosphorus atom and a nitrogen atom in the molecule, may be a combination of a compound containing a phosphorus atom in the molecule and a compound containing a nitrogen atom in the molecule, or may be a combination of two or more thereof. Among them, a compound containing both a phosphorus atom and a nitrogen atom in the molecule or a combination of a compound containing a phosphorus atom in the molecule and a compound containing a nitrogen atom in the molecule is preferable from the viewpoint of exhibiting a high flame retardant effect.

Examples of the compound containing both a phosphorus atom and a nitrogen atom in the molecule include the corresponding compounds among the compounds described as the phosphorus-containing flame retardant described above, and examples thereof include polyphosphates such as ammonium polyphosphate and melamine polyphosphate; phosphates such as melamine phosphate and phosphate ester amide; and pyrophosphates such as piperazine pyrophosphate and melamine pyrophosphate. These compounds may be used alone or in combination of two or more thereof.

In the case of a combination of a compound containing a phosphorus atom in the molecule and a compound containing a nitrogen atom in the molecule, examples of the compound containing a phosphorus atom include an organophosphorus compound and red phosphorus. In addition, examples of the compound containing a nitrogen atom in the molecule include hindered amine, melamine, ammonium borate, and ammonium carbonate. Among them, from the viewpoint of flame retardancy, an organophosphorus compound is preferable as the compound containing a phosphorus atom, and a hindered amine is preferable as the compound containing a nitrogen atom in the molecule. That is, the intumescent flame retardant preferably contains an organophosphorus compound and a hindered amine, and more preferably contains only the organophosphorus compound and the hindered amine. Note that, in the combination of the compound containing a phosphorus atom in the molecule and the compound containing a nitrogen atom in the molecule, the “compound containing a phosphorus atom” does not include a compound containing a phosphorus atom and further containing a nitrogen atom, and the “compound containing a nitrogen atom” does not include a compound containing a nitrogen atom and further containing a phosphorus atom.

Here, examples of the organophosphorus compound include a phosphonate, an organophosphorous acid ester, an organophosphinite, a metal salt of phosphinic acid, a metal salt of diphosphinic acid, a phosphinate, and a polyol phosphate alcohol. Among them, the phosphonate is preferable because a foamed molded article having more excellent non-ignition property and self-extinguishing property can be provided.

Note that the contents described in WO 2023/181879 can be appropriately referred to for the intumescent flame retardant and the organophosphorus compound, and the contents are incorporated as a part of the description of the present specification as they are.

As the phosphorus-containing flame retardant and the intumescent flame retardant, flame retardants containing both a piperazine pyrophosphate salt and a melamine pyrophosphate salt are preferable, and as a more preferred flame retardant, a flame retardant containing both a piperazine pyrophosphate salt and a melamine pyrophosphate salt is contained, and a mass ratio of a content of the melamine pyrophosphate salt to a content of the piperazine pyrophosphate salt (melamine pyrophosphate salt/piperazine pyrophosphate salt) in the polypropylene-based resin composition of the present invention is preferably 0.25 or more and 1.0 or less.

A molar ratio of pyrophosphoric acid to melamine of the melamine pyrophosphate salt is preferably 1:2. A molar ratio of pyrophosphoric acid to piperazine of piperazine pyrophosphate is preferably 1:1.

The melamine phosphate and the melamine polyphosphate can be obtained by reacting melamine with the corresponding phosphoric acid or polyphosphoric acid or salts thereof, respectively.

As the melamine pyrophosphate salt and the melamine polyphosphate salt, the melamine pyrophosphate salt and the melamine polyphosphate salt obtained by a method of thermally condensing monomelamine orthophosphate may be used, and the melamine pyrophosphate salt and the melamine polyphosphate salt obtained by these methods are preferable.

The piperazine phosphate salt and the piperazine polyphosphate salt can be obtained by reacting the corresponding phosphoric acid or polyphosphoric acid or salts thereof with piperazine.

As the pyrophosphoric acid piperazine salt and the polyphosphoric acid piperazine salt, a pyrophosphoric acid piperazine salt and a polyphosphoric acid piperazine salt obtained by a method of thermally condensing monomelamine diorthophosphate may be used, and the pyrophosphoric acid piperazine salt and the polyphosphoric acid piperazine salt obtained by these methods are preferable.

As the phosphate, a commercially available product can also be used. Examples of the commercially available product include “ADK STAB FP-2100J”, “ADK STAB FP-2200S”, “ADK STAB FP-2300S”, and “ADK STAB FP-2500S” manufactured by ADEKA CORPORATION, “FCP-796” manufactured by SUZUHIRO CHEMICAL CO., LTD., and “EXOLIT AP422” and “EXOLIT AP462” manufactured by Clariant Japan K.K.

Examples of the phosphoric acid ester include an aromatic phosphoric acid ester, an aliphatic phosphoric acid ester, and an oligomer or polymer obtained from the aromatic phosphoric acid ester and the aliphatic phosphoric acid ester.

Examples of the aromatic phosphoric acid ester include trixylenyl phosphate, tris(phenyl)phosphate, trinaphthyl phosphate, cresyl diphenyl phosphate, xylenyl diphenyl phosphate, diphenyl phosphate-2-methacryloyloxyethyl phosphate, resorcinol bis(diphenyl phosphate), resorcinol bis(dixylenyl phosphate), resorcinol bis(dicresyl phosphate), hydroquinone bis(dixylenyl phosphate), bisphenol A bis(diphenyl phosphate), and tetrakis(2,6-dimethylphenyl) 1,3-phenylene bisphosphate.

Examples of the aliphatic phosphoric acid ester include trimethyl phosphate, tributyl phosphate, tri(2-ethylhexyl)phosphate, tributoxyethyl phosphate, monoisodecyl phosphate, and 2-acryloyloxyethyl phosphate.

As the phosphoric acid ester, a commercially available product can be used. Examples of the commercially available product include “ADK STAB FP-600” and “ADK STAB FP-800” manufactured by ADEKA CORPORATION.

Examples of the metal oxide include zinc oxide, magnesium oxide, calcium oxide, silicon dioxide, titanium oxide, manganese oxide (MnO, MnO₂), iron oxide (FeO, Fe₂O₃, Fe₃O₄), copper oxide, nickel oxide, tin oxide, aluminum oxide, and calcium aluminate. As the metal oxide, zinc oxide, magnesium oxide, or calcium oxide is preferable, and zinc oxide is more preferable.

The metal oxide may be surface-treated. Examples of commercially available zinc oxide include two types of zinc oxide manufactured by SEIDO CHEMICAL INDUSTRY CO., LTD., one type of zinc oxide manufactured by Mitsui Mining and Smelting Company, Limited, partially coated zinc oxide manufactured by Mitsui Mining and Smelting Company, Limited, NANOFINE 50 (ultrafine zinc oxide having an average particle diameter of 0.02 μm: manufactured by SAKAI CHEMICAL INDUSTRY CO., LTD.), and NANOFINE K (ultrafine zinc oxide coated with zinc silicate having an average particle diameter of 0.02 μm: manufactured by SAKAI CHEMICAL INDUSTRY CO., LTD.).

The polyvalent hydroxyl group-containing compound is a compound having two or more hydroxyl groups. Examples of the polyvalent hydroxyl group-containing compound include pentaerythritol, dipentaerythritol, tripentaerythritol, polypentaerythritol having a degree of condensation of 4 or more, tris(hydroxyethyl) isocyanate, polyethylene glycol, glycerin, starch, glucose, cellulose, and sorbitol. As the polyvalent hydroxyl group-containing compound, a polyhydric alcohol compound is preferable because it has low water solubility and low hygroscopicity, pentaerythritol, dipentaerythritol, tripentaerythritol, or polypentaerythritol is more preferable, and pentaerythritol is still more preferable.

### <Content of Flame Retardant (B)>

A content of the flame retardant (B) in the polypropylene-based resin composition of the present invention is preferably 5 mass % or more, more preferably 10 mass % or more, and still more preferably 15 mass % or more, and is preferably 50 mass % or less, more preferably 45 mass % or less, and still more preferably 40 mass % or less, with respect to 100 mass % of the total amount of the polypropylene-based resin composition.

When the polypropylene-based resin composition of the present invention contains a phosphorus-containing flame retardant, a content of the flame retardant other than the phosphorus-containing flame retardant that can be contained in the polypropylene-based resin composition of the present invention is preferably 0 to 30 mass %, more preferably 0 to 20 mass %, and still more preferably 0 to 10 mass %, and may be 0 mass %, based on 100 mass % of the total amount of the polypropylene-based resin composition of the present invention.

### [Fibers (C)]

The polypropylene-based resin composition of the present invention contains fibers (C). The polypropylene-based resin composition of the present invention may contain one type of fiber, or may contain a combination of two or more types of fibers in an arbitrary ratio.

As the fibers (C), a fiber used as a reinforcing fiber of the resin molded article can be used without particular limitation. Examples of the fibers (C) include an inorganic fiber and an organic fiber. Examples of the inorganic fiber include fibers such as fibrous magnesium oxysulfate, a potassium titanate fiber, a magnesium hydroxide fiber, an aluminum borate fiber, a calcium silicate fiber, a calcium carbonate fiber, a carbon fiber, a glass fiber, a metal fiber, an asbestos fiber, a graphite fiber, wollastonite, sepiolite, a slag fiber, zonolite, ellestadite, a gypsum fiber, a silica fiber, a silica-alumina fiber, a boron nitride fiber, a silicon nitride fiber, and a boron fiber. Examples of the organic fiber include a polyester fiber, a nylon fiber, an acrylic fiber, a regenerated cellulose fiber, an acetate fiber, kenaf, ramie, cotton, jute, hemp, sisal, flax, linen, silk, Manila hemp, twill, wood pulp, waste paper, used paper, and wool.

As the fibers (C), an inorganic fiber is preferable, and a glass fiber is preferable.

A material of the glass fiber is not particularly limited, and any glass can be used. Examples of the material of the glass fiber include E glass (alkali-free glass), A glass, C glass, S glass, and D glass, and among them, E glass is preferable. As the glass fiber, a glass fiber produced by an arbitrary production method can be used.

The glass fiber may be treated with a sizing agent and/or a surface treatment agent.

The glass fiber is preferably subjected to a surface treatment with a surface treatment agent from the viewpoint of improving the dispersibility in the polypropylene-based polymer (A). Examples of the surface treatment agent include an organosilane coupling agent, a titanate coupling agent, an aluminate coupling agent, a zirconate coupling agent, a silicone compound, a higher fatty acid, a higher fatty acid metal salt, and a fatty acid ester.

Examples of the organosilane coupling agent include vinyltrimethoxysilane, γ-chloropropyltrimethoxysilane, γ-methacryloxypropyltrimethoxysilane, γ-aminopropyltrimethoxysilane, and 3-acryloxypropyltrimethoxysilane.

Examples of the titanate coupling agent include isopropyl triisostearoyl titanate, isopropyl tris(dioctyl pyrophosphate)titanate, and isopropyl tri(N-aminoethyl)titanate.

Examples of the aluminate coupling agent include acetoalkoxyaluminum diisopropylate.

Examples of the zirconate coupling agent include tetra(2,2-diallyloxymethyl)butyl, di(tridecyl)phosphite zirconate, and neopentyl(diallyl)oxy trineodecanoyl zirconate.

Examples of the silicone compound include silicone oil and a silicone resin.

Examples of the higher fatty acid include oleic acid, capric acid, lauric acid, palmitic acid, stearic acid, montanic acid, linoleic acid, rosin acid, linolenic acid, undecanoic acid, and undecenoic acid.

Examples of the higher fatty acid metal salt include a sodium salt, a lithium salt, a calcium salt, a magnesium salt, a zinc salt, and an aluminum salt of a fatty acid (for example, stearic acid or montanic acid) having 9 or more carbon atoms. Among them, calcium stearate, aluminum stearate, calcium montanate, and sodium montanate are preferable.

Examples of the fatty acid ester include polyhydric alcohol fatty acid ester such as glycerin fatty acid ester, α-sulfo fatty acid ester, polyoxyethylene sorbitan fatty acid ester, sorbitan fatty acid ester, polyethylene fatty acid ester, and sucrose fatty acid ester.

The amount of the surface treatment agent used is not particularly limited, and is preferably 0.01 to 5 parts by mass, and more preferably 0.1 to 3 parts by mass, based on 100 parts by mass of the glass fiber.

The glass fiber treated with the sizing agent is bound. Examples of the sizing agent include an epoxy-based sizing agent, an aromatic urethane-based sizing agent, an aliphatic urethane-based sizing agent, an acrylic sizing agent, and a maleic anhydride-modified polyolefin-based sizing agent.

As the sizing agent, a sizing agent that melts at a temperature of melt-kneading with the polypropylene-based polymer (A) is preferable, and a sizing agent that melts at 200° C. or lower is more preferable.

As the glass fiber, a so-called glass fiber chopped strand obtained by cutting a glass strand may also be used. From the viewpoint of further enhancing the effect of improving the rigidity and the effect of improving the impact strength of the molded article containing the polypropylene-based resin composition, it is preferable to use glass fibers that are chopped strands.

As the glass fiber, resin pellets containing glass fibers (glass fiber-containing resin pellets) may be used. In glass fiber-containing pellets, the length of the glass fiber (fiber length) is usually substantially the same as the length of the resin pellet in an extrusion direction.

The glass fiber-containing resin pellets can be produced by any method.

The glass fiber-containing pellets can be produced by, for example, a pultrusion molding method. The pultrusion molding method is usually a method in which a bundle of glass fibers is impregnated with a resin by melt-extruding the resin from a resin extruder while a plurality of continuous glass fibers are pulled out to integrate the plurality of bundles of glass fibers. A bundle of glass fibers impregnated with a resin is usually cooled and cut with a pelletizer to obtain glass fiber-containing resin pellets.

A content of the glass fibers in the glass fiber-containing pellets is preferably 50 to 99.9 mass %.

As the glass fiber, a commercially available product can be used.

### <Physical Properties and Properties of Fibers (C)>

A cross-sectional area of the fiber (C) is not particularly limited and can be appropriately set, and is 2×10⁻⁵ to 8×10⁻³ mm², more preferably 8×10⁻⁵ to 8×10⁻³ mm², and particularly preferably 8×10⁻⁵ to 8×10⁻⁴ mm², from the viewpoint of rigidity and suppression of deformation of the molded article.

The fibers (C) present in the polypropylene-based resin composition or the molded article of the present invention usually have an aspect ratio of 20 to 60. The aspect ratio is preferably 25 or more, more preferably 30 or more, still more preferably 58 or less, and particularly preferably 55 or less.

The aspect ratio of the fiber (C) can be measured by the following method.

2 g of the polypropylene-based resin composition or the molded article of the present invention is dissolved in boiling p-xylene for 2 hours to obtain a xylene insoluble component containing the fibers (C). Next, the fibers (C) in the xylene insoluble component are observed using a microscope, and the length and diameter of 200 fibers (C) are measured. A weight average fiber length and an average fiber diameter of 200 fibers (C) are calculated, and a ratio of the weight average fiber length to the average fiber diameter is taken as the aspect ratio of the fiber (C) contained in the polypropylene-based resin composition or the molded article of the present invention.

Here, the weight average fiber length can be calculated according to the following equation.

Weight average fiber length (Lw)=(Σqi×Li²)/(Σqi×Li)

In the above equation, Li is the length (fiber length) of the glass fiber, and qi is the number of glass fibers having the fiber length Li.

Note that, for flat fibers to be described below, the aspect ratio is calculated from the ratio of the weight average fiber length to the average fiber diameter of the “major axis” among fiber diameters.

Examples of the method for adjusting the fibers (C) contained in the polypropylene-based resin composition or the molded article of the present invention to the above-mentioned aspect ratio range include a method for appropriately adjusting a feeding position of the fibers (C) to an extruder, a temperature of the extruder, a screw rotation speed, a melt flow rate of a polypropylene-based polymer as a raw material, and a length (fiber length) and a fiber diameter of the fiber (C) as a raw material, when a raw material is kneaded in the extruder.

As a specific adjustment method, there is a method described in WO 2022/030480. In the present specification, the contents described in WO 2022/030480 can be referred to as appropriate, and the contents are incorporated as a part of the description of the present specification as they are.

For example, when the extruder temperature at the time of producing the polypropylene-based resin composition of the present invention is increased, the aspect ratio and the fiber length can be usually increased. When the melt flow rate of the polypropylene-based polymer (A) as a raw material is increased, the aspect ratio and the fiber length can be usually increased.

The length (fiber length) of the fiber (C) present in the polypropylene-based resin composition or the molded article of the present invention is preferably 200 μm or more, more preferably 300 μm or more, preferably 1000 μm, more preferably 900 μm or less, and still more preferably 800 μm or less as a weight average fiber length based on 200 fibers. The length of the fiber (C) can be measured by observation with a microscope. The method for adjusting the aspect ratio can be adopted as the method for preparing the fiber length.

The fibers (C) preferably include a flat fiber having a flat cross-sectional shape in which a ratio of a major axis to a minor axis [major axis/minor axis] in a cross section is 2.0 or more, and the fiber (C) is preferably a flat fiber having a flat cross-sectional shape in which a ratio of a major axis to a minor axis [major axis/minor axis] in a cross section is 2.0 or more.

The flat cross-sectional shape is a flat cross section in which a ratio of a major axis (corresponds to a maximum length of a cross section in a longitudinal direction, that is, a maximum height of the cross section when the flat fibers are arranged so that a major axis direction is vertical) to a minor axis (corresponds to a maximum length of the cross section in a short direction, that is, a maximum width of the cross section when the flat fibers are arranged so that a minor axis direction is horizontal) [major axis/minor axis] is 2.0 or more in a cross section intersecting the axis of the fiber (C), usually a vertical cross section. The ratio [major axis/minor axis] indicates a flat ratio of the flat cross-sectional shape of the flat fiber (Flat ratio), and the flat cross-sectional shape becomes circular as the ratio [major axis/minor axis] approaches 1.0. By containing flat fibers having a flat cross-sectional shape with the ratio [major axis/minor axis] of 2.0, it is possible to suppress melt sagging due to flame contact, and even when melt sagging occurs, the amount of deformation thereof can be homogenized to adjust the amount of deformation of the molded article to a level comparable to that before deformation. Furthermore, the amount of deformation caused by orientation anisotropy of fibers can also be homogenized, and the amount of deformation can be adjusted to a level comparable to that before deformation.

The above ratio [major axis/minor axis] is preferably 2.5 or more from the viewpoint of highly suppressing the deformation of the molded article, further reducing the amount of deformation, and adjusting the amount of deformation to a level comparable to that before deformation. On the other hand, an upper limit value of the ratio [major axis/minor axis] is not particularly limited, can be 8.0 or less, and is preferably 5.0 or less, and more preferably 4.5 or less, from the viewpoint of securing the strength of the flat fiber and suppressing the rigidity and thermal deformation of the molded article.

The ratio of major axis to minor axis [major axis/minor axis] of one flat fiber in the cross-section (flat cross-sectional shape) (hereinafter also referred to as “ratio [major axis/minor axis] of flat fiber” in the present invention) can be determined by observing an arbitrary flat cross section of the fiber with a microscope, measuring the minor axis and major axis, and dividing the major axis by the minor axis. In the present invention, the ratio of major axis to minor axis[major axis/minor axis] of the flat fibers in the cross-section is a value obtained by arithmetically averaging the ratios of major axis to minor axis[major axis/minor axis] in the cross-section of a plurality of, for example, 10 flat fibers to be measured.

In flat fibers, the major axis obtained as described above is not particularly limited, but may be, for example, 10 to 30 μm, and is preferably 15 to 25 μm. In addition, the minor axis of the flat fibers obtained as described above is not particularly limited, but may be, for example, 3 to 10 μm, and is preferably 4 to 8 μm.

The shape of the flat cross section can be a shape in which the circular cross section is collapsed in one diametrical direction, and examples thereof include a (substantially) rectangular shape, a (substantially) oval shape in which four corners of a rectangular shape are chamfered, an elliptical shape, and a shape (cocoon shape) in which the center of these shapes is constricted, and a (substantially) rectangular shape or a (substantially) oval shape are preferable. Note that, in the present invention, the shape such as a cocoon shape indicating a cross-sectional shape includes a shape that is partially deformed as long as the shape is maintained as a whole, in addition to a geometrically accurate shape. The cross section of the flat fiber used for calculating the ratio [major axis/minor axis] may be a cross section obtained by cutting the flat fiber (taken out from the molded article), or may be a cross section of a flat fiber appearing on a cut surface obtained by cutting the molded article.

Note that, in the present invention, when commercially available flat fibers are used in the preparation of the polypropylene-based resin composition of the present invention, the ratio of major axis to minor axis of the flat fibers [major axis/minor axis] in the cross-section may be calculated as described above, or a catalog value may be adopted.

The flat fibers can be produced, for example, by spinning using a nozzle having an appropriate hole shape such as an oval shape, a cocoon shape, an elliptical shape, or a rectangular slit shape as a bushing used for discharging the melt. In addition, it can also be produced by spinning the melt from a plurality of closely provided nozzles having various cross-sectional shapes (including a circular cross section) and joining the spun melt filaments to each other to form a single filament. For such a production technique, for example, the contents described in JP-A-7-291649, JP-A-2000-344541, and the like can be referred to as appropriate, and the contents are incorporated as a part of the description of the present specification as they are.

The fibers (C) may include two or more types of flat fibers.

A content (mass ratio) of the flat fibers included in the fibers (C) is not particularly limited, can be more than 0 mass % and 100 mass % or less in 100 mass % of the total mass of the fibers (C), and is preferably 20 mass % or more, more preferably 30 mass % or more, and particularly preferably 50 mass % or more in that the overall amount of deformation of the molded article can be suppressed to a level comparable to that before deformation. An upper limit of the content may be 98 mass % or less or 90 mass % or less.

### <Content of Fibers (C)>

A content of the fibers (C) in the polypropylene-based resin composition of the present invention is not particularly limited, and is preferably 5 mass % or more, more preferably 8 mass % or more, and still more preferably 10 mass % or more, and is preferably 50 mass % or less, more preferably 46 mass % or less, and still more preferably 40 mass % or less, with respect to 100 mass % of the total amount of the polypropylene-based resin composition, from the viewpoint of enhancing the rigidity of the molded article and suppressing the amount of deformation.

### [Acid-Modified Polyolefin-Based Polymer (D)]

The polypropylene-based resin composition of the present invention may contain an acid-modified polyolefin-based polymer (D) in addition to the polypropylene-based polymer (A), the flame retardant (B), and the fibers (C). When the polypropylene-based resin composition of the present invention contains the acid-modified polyolefin-based polymer (D), the compatibility between the polypropylene-based polymer (A) and the fibers (C) can be enhanced to strengthen the rigidity when the polypropylene-based resin composition is formed into a molded article, and the deformation of melt sagging due to flame contact and the deformation caused by orientation anisotropy of the fibers can be highly suppressed.

In the present invention, the acid-modified polyolefin-based polymer means a polymer obtained by modifying a polyolefin-based polymer with an unsaturated carboxylic acid and/or an unsaturated carboxylic acid derivative.

Examples of the acid-modified polyolefin-based polymer include an acid-modified polyethylene-based polymer and an acid-modified polypropylene-based polymer.

The acid-modified polyethylene-based polymer means a polymer obtained by modifying a polyethylene-based polymer with an unsaturated carboxylic acid and/or an unsaturated carboxylic acid derivative.

The acid-modified polypropylene-based polymer means a polymer obtained by modifying a polypropylene-based polymer with an unsaturated carboxylic acid and/or an unsaturated carboxylic acid derivative.

The polyolefin-based polymer to be modified is a homopolymer of one type of olefin or a copolymer of two or more types of olefins. Examples of the polyolefin-based polymer to be modified include a polyethylene-based polymer and a polypropylene-based polymer.

The polyethylene-based polymer to be modified is a polymer containing an ethylene unit in an amount of more than 50 mass % with respect to the amount of all structural units of the polymer. The ethylene unit in the polyethylene-based polymer is usually 100 mass % or less.

The polypropylene-based polymer to be modified is a polymer containing a propylene unit in an amount of more than 50 mass % with respect to the amount of all structural units of the polymer. The propylene unit in the polypropylene-based polymer is usually 100 mass % or less. Examples of the polypropylene-based polymer to be acid-modified include the examples and preferred examples shown as the polypropylene-based polymer (A).

The acid-modified polypropylene-based polymer is usually a polymer having a partial structure of a polypropylene-based polymer and a partial structure derived from an unsaturated carboxylic acid and/or an unsaturated carboxylic acid derivative. Examples of the acid-modified polypropylene-based polymer include (a) a polymer obtained by graft-polymerizing an unsaturated carboxylic acid and/or an unsaturated carboxylic acid derivative with a propylene homopolymer, (b) a polymer obtained by graft-polymerizing an unsaturated carboxylic acid and/or an unsaturated carboxylic acid derivative with a copolymer obtained by copolymerizing propylene and one or more other monomers selected from the group consisting of ethylene and α-olefins having 4 or more carbon atoms, and (c) a modified polypropylene-based polymer obtained by graft-polymerizing an unsaturated carboxylic acid and/or an unsaturated carboxylic acid derivative with a block copolymer obtained by copolymerizing ethylene and one or more other monomers selected from the group consisting of α-olefins having 4 or more carbon atoms after homopolymerizing propylene.

The acid-modified polypropylene-based polymer to be subjected to acid modification may be one type of polymer or a combination of two or more types of polymers in any ratio. Therefore, the acid-modified polypropylene-based polymer to be subjected to acid modification may be the heterophasic propylene polymerization material described above.

Examples of the unsaturated carboxylic acid include maleic acid, fumaric acid, itaconic acid, acrylic acid, and methacrylic acid.

Examples of the unsaturated carboxylic acid derivative include an acid anhydride, an ester compound, an amide compound, an imide compound, and a metal salt of an unsaturated carboxylic acid. Examples of the unsaturated carboxylic acid derivative include maleic anhydride, itaconic anhydride, methyl acrylate, ethyl acrylate, butyl acrylate, methyl methacrylate, ethyl methacrylate, butyl methacrylate, 2-hydroxyethyl methacrylate, maleic monoethyl ester, maleic acid diethyl ester, fumaric acid monomethyl ester, fumaric acid dimethyl ester, acrylamide, methacrylamide, maleic acid monoamide, maleic acid diamide, fumaric acid monoamide, maleimide, N-butyl maleimide, and sodium methacrylate.

As the unsaturated carboxylic acid, for example, maleic acid and acrylic acid are preferable, and as the unsaturated carboxylic acid derivative, maleic anhydride and 2-hydroxyethyl methacrylate are preferable.

As the acid-modified polypropylene-based polymer, the polymer of the (b) above and the polymer of the (c) above are preferable. In the present invention, the acid-modified polypropylene-based polymer is preferably a modified polyolefin-based polymer obtained by graft-polymerizing maleic anhydride with a polyolefin-based polymer containing a propylene unit in an amount of more than 50 mass % in all structural units.

A total content (also referred to as “graft ratio”) of the unsaturated carboxylic acid unit and the unsaturated carboxylic acid derivative unit in the acid-modified polyolefin-based polymer is preferably 0.1 to 20 mass % and more preferably 0.1 to 10 mass % with respect to 100 mass % of the amount of the acid-modified polyolefin-based polymer from the viewpoint of the rigidity and hardness of the molded article obtained from the polypropylene-based resin composition of the present invention. Here, when the acid-modified polyolefin-based polymer contains only one type of an unsaturated carboxylic acid unit and an unsaturated carboxylic acid derivative unit, a total content means a content of the one type of unit.

Note that, as the content of the unsaturated carboxylic acid unit and the unsaturated carboxylic acid derivative unit, a value calculated by quantifying the absorption based on the unsaturated carboxylic acid and the unsaturated carboxylic acid derivative by an infrared absorption spectrum or NMR spectrum is used.

The grafting efficiency of the unsaturated carboxylic acid and/or the unsaturated carboxylic acid derivative of the acid-modified polyolefin-based polymer is preferably 0.51 or more from the viewpoint of the rigidity and impact strength of the molded article obtained from the polypropylene-based resin composition of the present invention.

The “grafting efficiency of the acid-modified polyolefin-based polymer” means “the ratio of the amount of the unsaturated carboxylic acid and/or the unsaturated carboxylic acid derivative chemically bonded to the polymer to the total amount of the unsaturated carboxylic acid and/or the unsaturated carboxylic acid derivative chemically bonded to the polymer and the unsaturated carboxylic acid and/or the unsaturated carboxylic acid derivative not chemically bonded to the polymer contained in the acid-modified polyolefin-based polymer”. The graft efficiency in the graft polymerization of the unsaturated carboxylic acid and/or the unsaturated carboxylic acid derivative can be determined by the following procedures (1) to (9):
(1) dissolving 1.0 g of the acid-modified polyolefin-based polymer in 100 ml of xylene;
(2) adding dropwise the xylene solution to 1,000 ml of methanol under stirring to reprecipitate the acid-modified polyolefin-based polymer;
(3) recovering the reprecipitated acid-modified polyolefin-based polymer;
(4) subjecting the recovered acid-modified polyolefin-based polymer to vacuum drying at 80° C. for 8 hours to obtain a purified acid-modified polyolefin-based polymer;
(5) hot-pressing the purified acid-modified polyolefin-based polymer to produce a film having a thickness of 100 μm;
(6) measuring an infrared absorption spectrum of the film;
(7) quantifying absorption based on the unsaturated carboxylic acid and/or the unsaturated carboxylic acid derivative from the infrared absorption spectrum, and calculating a content (X1) of the unsaturated carboxylic acid and/or the unsaturated carboxylic acid derivative reacted with a polyolefin-based polymer in the acid-modified polyolefin-based polymer;
(8) separately performing the procedures (5) and (6) for the acid-modified polyolefin-based polymer that is not subjected to purification treatment, and calculating a content (X2) of the unsaturated carboxylic acid and/or the unsaturated carboxylic acid derivative in the acid-modified polyolefin-based polymer that is not subjected to purification treatment from the infrared absorption spectrum (X2 is the sum of the content (X1) of the unsaturated carboxylic acid and/or unsaturated carboxylic acid derivative reacted with the polypropylene-based polymer and the content of the unsaturated carboxylic acid and/or unsaturated carboxylic acid derivative not reacted (that is, free) with the polyolefin polymer); and
(9) calculating graft efficiency from an equation:

$$graft efficiency = X 1 / X 2.$$

An MFR of the acid-modified polypropylene-based polymer is preferably 5 to 400 g/10 min, more preferably 10 to 200 g/10 min, and particularly preferably 20 to 200 g/10 min, from the viewpoint of mechanical strength and production stability.

### <Content of Acid-Modified Polypropylene-Based Polymer (D)>

A content of the acid-modified polypropylene-based polymer (D) in the polypropylene-based resin composition is preferably 0.1 mass % or more, more preferably 0.2 mass % or more, and still more preferably 0.5 mass % or more, and is preferably 5.0 mass % or less, more preferably 3.0 mass % or less, and still more preferably 2.5 mass % or less, with respect to 100 mass % of the total amount of the polypropylene-based resin composition.

### [Other Components]

The polypropylene-based resin composition of the present invention may contain other components (hereinafter, referred to as “other components”) as further optional components in addition to the components (A) to (D) described above.

Examples of the other components include an elastomer, a neutralizing agent, an antioxidant, an ultraviolet absorber, a lubricant, an antistatic agent, an antiblocking agent, a processing aid, an organic peroxide, a colorant (an inorganic pigment, an organic pigment, and the like), a pigment dispersant, a foaming agent, a foaming nucleating agent, a plasticizer, a crosslinking agent, a crosslinking aid, a brightness enhancer, an antibacterial agent, a light diffusing agent, and a molecular weight adjusting agent. The polypropylene-based resin composition of the present invention may contain one type of other component, or may contain a combination of two or more types of fibers in an arbitrary ratio.

Examples of the elastomer include a random copolymer having an ethylene unit and an α-olefin unit having 4 to 10 carbon atoms. The random copolymer is preferably a copolymer having an MFR of 0.1 to 50 g/10 min.

Examples of the α-olefin having 4 to 10 carbon atoms that constitutes the random copolymer as an elastomer include an α-olefin similar to the α-olefin having 4 to 10 carbon atoms that constitute the polypropylene-based polymer (A), and include linear or branched α-olefins such as 1-butene, 1-pentene, 1-hexene, 4-methyl-1-pentene, 1-octene, and 1-decene, and cyclic α-olefins such as vinylcyclopropane and vinylcyclobutane, and 1-butene, 1-hexene, and 1-octene are preferable.

Examples of the random copolymer which is an elastomer include an ethylene-1-butene random copolymer, an ethylene-1-hexene random copolymer, an ethylene-1-octene random copolymer, an ethylene-1-decene random copolymer, an ethylene-(3-methyl-1-butene) random copolymer, and a copolymer of ethylene and an α-olefin having a cyclic structure.

A content of the α-olefin in the random copolymer is preferably 1 to 49 mass %, more preferably 5 to 49 mass %, and still more preferably 24 to 49 mass %, with respect to 100 mass % of the mass of the random copolymer.

In addition, from the viewpoint of improving the impact resistance of the molded article containing the polypropylene-based resin composition of the present invention, a density of the random copolymer is preferably 0.850 to 0.890 g/cm³, more preferably 0.850 to 0.880 g/cm³, and still more preferably 0.855 to 0.867 g/cm³.

The random copolymer which is an elastomer can be produced by polymerizing a monomer using a polymerization catalyst. Examples of the polymerization catalyst include the catalysts mentioned as the polymerization catalyst for producing the polypropylene-based polymer.

As the random copolymer, a commercially available product may be used. Examples of the commercially available product as the random copolymer which is an elastomer include ENGAGE (registered trademark) manufactured by Dow Chemical Japan Ltd., TAFMER (registered trademark) manufactured by Mitsui Chemicals, Inc., NEO-ZEX (registered trademark) and ULT-ZEX (registered trademark) manufactured by Prime Polymer Co., Ltd., and EXCELLEN FX (registered trademark), SUMICASEN (registered trademark), and ESPRENE SPO (registered trademark) manufactured by Sumitomo Chemical Co., Ltd.

A content of the elastomer in the polypropylene-based resin composition of the present invention is preferably 0 to 30 mass % and more preferably 0 to 10 mass % based on 100 mass % of the polypropylene-based resin composition of the present invention. In the present invention, the content of the elastomer in the polypropylene-based resin composition of the present invention may be 5 to 30 mass %.

### [Physical Properties of Polypropylene-Based Resin Composition]

A melt flow rate of the polypropylene-based resin composition of the present invention is preferably 0.1 g/10 min or more, more preferably 1 g/10 min or more, preferably 400 g/10 min or less, more preferably 300 g/10 min or less, and still more preferably 200 g/10 min or less. When the MFR of the polypropylene-based resin composition of the present invention is less than or equal to the upper limit value of the above range, the flame retardant performance of the polypropylene-based resin composition of the present invention can be effectively improved, and when the MFR is greater than or equal to the lower limit value of the above range, the weld strength of a molded article containing the polypropylene-based resin composition of the present invention can be improved.

In the present invention, the polypropylene-based resin composition of the present invention is not particularly limited in terms of the properties and form as long as it contains the polypropylene-based polymer (A), the flame retardant (B), and the fibers (C), and contains a mixture of the respective components (melt-kneaded product), for example, a molded article in addition to an unmolded article such as a strand or a pellet. The shape of the pellet is not particularly limited, and examples thereof include a granular shape and a tablet shape. For example, the pellet can be produced by preparing a propylene-based resin composition in a strand shape and then cutting the propylene-based resin composition into an appropriate length. Note that, in the present invention, the “unmolded article” refers to a material that is not molded into a shape and a dimension suitable for various applications and is used as a molding material, and the “molded article” refers to a material molded into a shape and a dimension suitable for various applications.

### [Method for Preparing Polypropylene-Based Resin Composition]

The polypropylene-based resin composition of the present invention can be prepared by a known method, and usually can be prepared by melting and kneading each component described above. The order of kneading the respective components is not particularly limited. For example, all the components may be collectively charged into a melt-kneading apparatus and kneaded, or a mixture obtained by kneading some components and the remaining components may be kneaded. Here, a kneading method and a kneading period of the fibers (C) are not particularly limited, but are preferably a kneading method and a kneading period described in the preferred preparation method described below.

A melt-kneading temperature is not particularly limited, and is appropriately determined. The melt-kneading temperature is usually preferably 170° C. or higher, more preferably 180° C. or higher, and still more preferably 200° C. or higher, and is preferably 250° C. or lower. A melt-kneading time is also not particularly limited, and is appropriately determined.

A conventionally known melt-kneading apparatus can be used as a melt-kneading apparatus for melt-kneading for preparing the polypropylene-based resin composition of the present invention, and examples of a suitable melt-kneading apparatus include a Banbury mixer, a single-screw extruder, a twin-screw rotating extruder, and a twin-screw rotating extruder. Examples of the melt-kneading apparatus include ZSK (registered trademark) manufactured by Coperion GmbH, TEM (registered trademark) manufactured by Toshiba Machine Co., Ltd., TEX (registered trademark) manufactured by The Japan Steel Works, Ltd., KZW (registered trademark) manufactured by TECHNOVEL CORPORATION, CMP (registered trademark) and TEX (registered trademark) manufactured by The Japan Steel Works, Ltd., and FCM (registered trademark), NCM (registered trademark), and LCM (registered trademark) manufactured by Kobe Steel, Ltd.

Examples of a preferred method for preparing the polypropylene-based resin composition of the present invention include a method in which a raw material (1) containing a polypropylene-based polymer (A) and a flame retardant (B) is supplied into a cylinder of a twin-screw kneading extruder including a cylinder and two screws at a distance L1 from an upstream end of the two screws, fibers (C) are supplied into the cylinder at a distance L2 from the upstream end of the two screws, and melt-kneaded, and performing melting and kneading. Here, L1/L is preferably in a range of 0 or more and less than 0.3, and L2/L is preferably in a range of 0.3 to 0.9, more preferably 0.5 or more, still more preferably 0.6 or more, particularly preferably 0.5 to 0.9, and most preferably 0.6 to 0.9. Usually, when L2/L is reduced, an aspect ratio of the fiber (C) contained in the polypropylene-based resin composition of the present invention can be reduced, and when L2/L is increased, the aspect ratio can be increased. Here, L is the length of the screw from the upstream end to the downstream end in the direction of the resin flow to be kneaded (that is, the total length of the screw).

The preferred preparation method is particularly suitably employed when a polypropylene-based resin composition containing glass fibers as the fibers (C) is prepared.

The raw material (1) may contain, as an optional component, a molecular weight modifier for adjusting the molecular weight of the polypropylene-based polymer. Examples of the molecular weight modifier include organic peroxides. The molecular weight modifier may be contained in the raw material (1) as a form of a masterbatch diluted with an arbitrary resin.

The polypropylene-based resin composition of the present invention is suitable as a material for forming a molded article, particularly a molded article capable of achieving excellent flame retardancy and the amount of deformation at a level comparable to that before deformation, and is suitable as a material for forming an injection molded article when attention is paid to a molding method.

### [[Molded Article]]

The molded article of the present invention is a molded article containing the polypropylene-based resin composition of the present invention. The molded article of the present invention is a molded article obtained by molding the molten mixture of the respective components or the polypropylene-based resin composition of the present invention by a known molding method.

The polypropylene-based resin composition of the present invention contained in the molded article is the same as described above in [Polypropylene-based resin composition of present invention].

The molded article can be molded simultaneously or continuously with the preparation (melt-mixing) of the polypropylene-based resin composition of the present invention, or can be obtained by molding the polypropylene-based resin composition again by various molding methods after preparing the polypropylene-based resin composition of the present invention. The molding method is not particularly limited, and a known molding method can be applied, and for example, an injection molding method, an extrusion molding method, a compression molding method, a modified molding method, a vacuum molding method, a sheet molding method, a roll molding method, a hot press molding method, a foam molding method, an injection press molding method, a blow molding method, a gas injection molding method, and the like can be applied, and the injection molding method is preferable. As the injection molding method, in addition to a general injection molding method, an injection foam molding method, a supercritical injection foam molding method, an ultrahigh speed injection molding method, an injection compression molding method, a gas-assist injection molding method, a sandwich molding method, a sandwich foam molding method, and an insert-outsert molding method can be applied. The molded article of the present invention is preferably an injection molded article molded by an injection molding method.

The molding conditions in each molding method are not particularly limited as long as the molten mixture of the respective components or the polypropylene-based resin composition of the present invention can be molded in a molten state, and can be appropriately set according to the composition, physical properties, and the like of the molten mixture of the respective components or the polypropylene-based resin composition of the present invention, and the kneading method and kneading conditions (kneading temperature) in the preparation of the polypropylene-based resin composition of the present invention can be preferably applied.

The shape, size, and the like of the molded article of the present invention are appropriately determined according to the application. For example, an outer dimension of the molded article is 0.5 to 2 m long, 0.5 to 2 m wide, and 1 to 10 mm thick. The shape of the molded article is appropriately determined according to the application, and examples thereof include a plate shape and a hollow shape.

The molded article of the present invention may be a molded article formed of only the molded product of the polypropylene-based resin composition of the present invention, or may be a molded article formed of the molded product and another member. Examples of the other member include a surface layer (coating layer), a colored layer, and a reinforcing layer. In addition, the molded article of the present invention may be subjected to a surface treatment such as a hard coat, a water repellent treatment, or an antibacterial treatment as necessary.

Since the molded article of the present invention contains the polypropylene-based resin composition of the present invention, flame retardancy is excellent, and even when the molded article is deformed due to flame contact and melt sagging occurs, the amount of deformation is small and can be at a level comparable to that before deformation (the molded article is deformed due to flame contact at a level that is overall small and comparable to that before deformation). Preferably, in the molded article of the present invention, the amount of deformation of the molded article caused by the arrangement anisotropy of the fibers (C) can also be at a level overall comparable to that before deformation.

The molded article of the present invention is a molded article (particularly, injection molded article) having excellent flame retardancy and a small amount of deformation at a level comparable to that before deformation. Examples of the molded article include an injection molded article, an extrusion molded article, a compression molded article, a modified molded article, a vacuum molded article, a sheet molded article, a roll molded article, a hot press molded article, a foam molded article, an injection press molded article, a blow molded article, and a gas injection molded article.

The molded article of the present invention can be suitably used as various members (for example, interior and exterior parts of automobiles and parts in engine rooms, two-wheeled vehicle parts, parts of electrical products, various containers, and furniture). Examples of the interior and exterior parts of automobiles include an instrument panel, a door trim, a pillar, a side protector, a console box, a column cover, a bumper, a fender, and a wheel cover. Examples of the parts in engine rooms of automobiles include a battery case and an engine cover. Examples of the two-wheeled vehicle component include cowling and a muffler cover.

### EXAMPLES

Hereinafter, the present invention will be described in more detail with reference to Examples. However, the present invention is not limited to these Examples.

In the following description, “%” and “part(s)” representing amounts are based on mass unless otherwise specified. In addition, the operations described below were performed under the conditions of normal temperature and normal pressure unless otherwise specified.

The components used in Examples and Comparative Examples are shown below.

### (1) Polypropylene-Based Polymer (A)

Using the polymerization catalyst obtained by the method described in Example 1 of JP-A-2004-182981, a propylene homopolymer was produced by a gas phase polymerization method under such conditions that a polypropylene-based polymer having the following physical properties was obtained.

### (A-1) Propylene Homopolymer

MFR (230° C. and load of 2.16 kgf): 18 g/10 min

### (A-2) Propylene Homopolymer

MFR (230° C. and load of 2.16 kgf): 120 g/10 min

### (A-3) Heterophasic Propylene Polymerization Material

A heterophasic propylene polymerization material (A-3) as a polypropylene-based polymer (A) containing 79 parts by mass of a propylene homopolymer component (a) as a polymer (I) and 21 parts by mass of a propylene-ethylene random copolymer component (b) as a polymer (II) was produced by a liquid-gas phase polymerization method using a polymerization catalyst obtained by the method described in Example 1 of JP-A-2004-182981.

The physical properties were as follows.
Melt flow rate (230° C. and load of 2.16 kgf): 60 g/10 min

### (a) Propylene Homopolymer Component

Limiting viscosity: 1.06 dL/g

### (b) Propylene-Ethylene Random Copolymer

Limiting viscosity: 2.8 dL/g
Content of structural unit derived from ethylene: 33 mass %

The content of the structural unit derived from ethylene in the propylene-ethylene random copolymer (b) was determined from a ¹³C-NMR spectrum measured under the following conditions based on a report by Kakugo et al. (Macromolecules, 15, 1150-1152 (1982)). The ¹³C-NMR spectrum was measured under the following conditions using a sample obtained by uniformly dissolving about 200 mg of the heterophasic propylene polymerization material (A-3) in 3 mL of ortho-dichlorobenzene in a test tube having a diameter of 10 mm.
Measurement temperature: 135° C.
Pulse repeating time: 10 seconds
Pulse width: 45°
Number of integrations: 2,500 times

### (2) Flame Retardant (B)

The following flame retardants were prepared.

### (B-1) Flame Retardant (Intumescent Flame Retardant)

Product name: ADK STAB FP-2500S (manufactured by ADEKA CORPORATION)
Main component: melamine phosphate, piperazine phosphate

### (B-2) Flame Retardant (Intumescent Flame Retardant)

Product name: ADK STAB FP-2300S (manufactured by ADEKA CORPORATION)
Main component: melamine phosphate, piperazine phosphate

### (B-3) Flame Retardant (Intumescent Flame Retardant)

Ammonium polyphosphate flame retardant
Product name: HP-FR-8300 (manufactured by Xusen)
Main component: ammonium polyphosphate

### (3) Fibers (C)

Each fiber shown below and the like were prepared.

Note that, although the glass fibers (C-3), the glass flakes (C-4), and the talc (C-5) do not correspond to the fibers (C), they are included in the classification of the fibers (C) in the present Example.

### (C-1) Glass Fibers (Chopped Strands)

Product name: ESC03T-480FGF (manufactured by Nippon Electric Glass Co., Ltd.)
Major axis: 20 μm (catalog value)
Minor axis: 5 μm (catalogue value)
Fiber length: 4 mm (catalog value)
Ratios of major axis to minor axis[major axis/minor axis] in the cross-section(Flat ratio): 4.0

### (C-2) Glass Fibers (Chopped Strands)

Major axis: 18 μm (catalog value)
Minor axis: 6 μm (catalogue value)
Fiber length: 4 mm (catalog value)
Ratios of major axis to minor axis[major axis/minor axis] in the cross-section(Flat ratio): 3.0

### (C-3) Glass Fibers (Chopped Strands)

Product name: ESC03T-480H (manufactured by Nippon Electric Glass Co., Ltd.)
Diameter: 10.5 μm (catalogue value)
Fiber length: 3.0 mm (catalog value)
Ratios of major axis to minor axis[major axis/minor axis] in the cross-section(Flat ratio): 1.0

### (C-4) Glass Flakes

Product name: MEG160FY-M04 (manufactured by Nippon Electric Glass Co., Ltd.)
Scaly glass having average thickness of about 0.7 μm and average particle size of about 160 μm

### (C-5) Talc

Product name: UPN TT-K (manufactured by Hayashi Kasei Co., Ltd.)

### (4) Acid-Modified Polyolefin-Based Polymer (D)

Maleic anhydride-modified polypropylene (hereinafter, may be referred to as “acid-modified PP”) (D-1) was produced as an acid-modified polyolefin-based polymer (D) in the following manner.

That is, 1.0 part by mass of maleic anhydride, 0.14 parts by mass of di-(tert-butyl peroxy)diisopropylbenzene (product name: PERBUTYL P, manufactured by NOF CORPORATION), 0.05 parts by mass of dicetyl peroxydicarbonate (product name: Perkadox 24-FL, manufactured by Kayaku Akzo Corporation), 0.05 parts by mass of calcium stearate (product name: AR-2, manufactured by SAKAI CHEMICAL INDUSTRY CO., LTD.), and 0.3 parts by mass of pentaerythritol tetrakis[3-(3,5-di-tert-butyl-4-hydroxyphenyl)propionate](product name: Songnox1010, manufactured by SONGWON) as an antioxidant were added to 100 parts by mass of a polypropylene resin powder (limiting viscosity [η]=3.0 dl/g, ethylene content: 0.2 mass %), and the mixture was sufficiently premixed and then supplied from a supply port of a twin-screw extruder for kneading to obtain acid-modified PP (D-1). The resulting acid-modified PP had an MFR (230° C., load 2.16 kgf) of 170 g/10 min and a graft ratio of 0.32%.

### [Evaluation]

The evaluation was performed according to the test method shown below.

### (Flammability According to UL94-V Standard)

Each of the resin compositions prepared in Examples and Comparative Examples was supplied to an injection molding machine “IS100EN” manufactured by Toshiba Machine Co., Ltd., and injection molding was performed under the conditions of a molding temperature of 220° C. and a mold cooling temperature of 50° C. to prepare a test flat plate having a size of 160 mm (length)×160 mm (width)×2.0 mm (thickness). A test piece having a size of 127 mm (length)×13 mm (width)×2.0 mm (thickness) was cut out from the obtained test plate having a thickness of 2.0 mm in the MD. Using the obtained test piece, the flame retardancy of the test piece was evaluated according to the UL94-V standard.

In the evaluation, according to the UL94-V standard, a case where the evaluation passed the determination criterion V-0 was defined as “V-0”, a case where the evaluation passed the determination criterion V-1 was defined as “V-1”, a case where the evaluation passed the determination criterion V-2 was defined as “V-2”, and a case where the evaluation did not pass the determination criterion V-2 was defined as “failure”. Note that, as for the flame retardancy, V-0 is superior to V-1, and V-1 is superior to V-2.

### (Melt Sagging (Deformation) Accompanying Combustion of Test Piece)

Each of the resin compositions prepared in Examples and Comparative Examples was supplied to an injection molding machine “IS100EN” manufactured by Toshiba Machine Co., Ltd., and injection molding was performed under the conditions of a molding temperature of 220° C. and a mold cooling temperature of 50° C. to prepare a test flat plate having a size of 160 mm (length)×160 mm (width)×2.0 mm (thickness). The obtained test plate having a thickness of 2.0 mm was cut into a size of 127 mm (length)×13 mm (width)×2.0 mm (thickness). Two types of test pieces having different cutting directions were prepared for each resin composition, with the cutting directions being two directions of the MD and the TD. Here, the MD was a direction parallel to the flow direction of the resin composition during injection molding, and the TD was a direction perpendicular to the flow direction of the resin composition during injection molding. The obtained test piece was horizontally fixed to the ground and brought into contact with flame at the end of the test piece for 20 seconds using a gas burner. The flame strength was the same as that in the UL94-V test, and the test piece was brought into contact with the flame perpendicularly. After the end of the test, the length (the amount of deformation of the end of the test piece in the vertical direction by own weight from the fixed surface) of the vertical bending from the test piece was measured using a ruler.

Note that the case where the test piece was completely burned and the amount of deformation could not be measured was defined as “completely burned”.

### Example 1

48.5 parts by mass of polypropylene (A-2), 1.5 parts by mass of modified PP (D-1), 20 parts by mass of flame retardant (B-1), and 100 parts by mass of the total of (A-1), (D-1), (B-1), and (C-1) described below were melt-kneaded with 0.05 parts by mass of calcium stearate (product name: Calcium stearate S, manufactured by NOF CORPORATION) as a neutralizing agent, 0.2 parts by mass of 2,3-bis[[3-[3,5-di-tert-butyl-4-hydroxyphenyl]propionohydrazine (product name: Rianox MD-1024, manufactured by RIANLON CORPORATION) as a metal deactivator, 0.2 parts by mass of tris(3,5-di-tert-butyl-4-hydroxybenzyl)isocyanurate (product name: Irganox3114, manufactured by BASF SE) as an antioxidant, 0.2 parts by mass of 3,9-bis(2,4-di-tert-butylphenoxy)-2,4,8,10-tetraoxaspiro[5·5]undecane (product name: Songnox6260, manufactured by SONGWON), and 0.25 parts by mass of distearyl-3,3-thiodipropionate (product name: Sumilizer TPS, manufactured by Sumitomo Chemical Co., Ltd.) at a temperature of 200 to 230° C. and a screw rotation speed of 400 rpm by a twin-screw kneading extruder, 30 parts by mass of glass fibers (C-1) was side-fed into the extruder, specifically from a position corresponding to about 70% (L2/L=0.7) of the total screw length, and the glass fibers (C-1) was passed through a cold water tank and then cut into strands with a strand cutter, thereby obtaining pellets (corresponding to a polypropylene-based resin composition).

The obtained pellets were dried in a hot air dryer at 100° C. for 2 hours, and then molded by each molding machine in the above evaluation to produce an injection molded article.

### Examples 2 to 5 and Comparative Examples 1 to 6

Pellets of polypropylene-based resin compositions of Examples 2 to 5 and Comparative Examples 1 to 6 were obtained, respectively, in the same manner as in Example 1, except that the components (A) to (D) were changed to the components and the contents shown in Tables 1 and 2 in Example 1, and injection molded bodies of Examples 2 to 5 and Comparative Examples 1 to 6 were produced, respectively.

### Comparative Example 7

72 parts by mass of polypropylene (A-1), 28 parts by mass of flame retardant (B-1), and 100 parts by mass of a mixture thereof were melt-kneaded with 0.05 parts by mass of calcium stearate (product name: Calcium stearate S, manufactured by NOF CORPORATION) as a neutralizing agent, 0.2 parts by mass of 2,3-bis[[3-[3,5-di-tert-butyl-4-hydroxyphenyl]propionohydrazine (product name: Rianox MD-1024, manufactured by RIANLON CORPORATION) as a metal deactivator, 0.2 parts by mass of tris(3,5-di-tert-butyl-4-hydroxybenzyl)isocyanurate (product name: Irganox3114, manufactured by BASF SE) as an antioxidant, 0.2 parts by mass of 3,9-bis(2,4-di-tert-butylphenoxy)-2,4,8,10-tetraoxaspiro[5·5]undecane (product name: Songnox6260, manufactured by SONGWON), and 0.25 parts by mass of distearyl-3,3-thiodipropionate (product name: Sumilizer TPS, manufactured by Sumitomo Chemical Co., Ltd.) at a temperature of 200 to 230° C. and a screw rotation speed of 400 rpm by a twin-screw kneading extruder, passed through a cold water tank, and then cut into strands with a strand cutter, thereby obtaining pellets.

The obtained pellets were dried in a hot air dryer at 100° C. for 2 hours, and then molded by each molding machine in the above evaluation to produce an injection molded article.

### Comparative Examples 8 and 9

Pellets of polypropylene-based resin compositions of Comparative Examples 8 and 9 were obtained, respectively, in the same manner as in Comparative Example 7, except that the components (A) and (B) were changed to the components and the contents shown in Table 2 and the components (C) and (D) were mixed in the content shown in Table 2 in Comparative Example 7, and injection molded bodies of Comparative Examples 8 and 9 were produced, respectively.

Using the obtained pellets of each polypropylene-based resin composition, (Flammability according to UL94-V standard) and (Melt sagging associated with combustion of test piece) were evaluated by the evaluation method described above. The results are shown in Table 1 and 2.

It was confirmed that the average fiber length of the fibers (C-1) and (C-2) present in each of the polypropylene-based resin compositions of Examples 1 to 5 and in the injection molded article was in a range of 200 to 800 μm.

TABLE 1

| | | | | Example | | | | |
|---|---|---|---|---|---|---|---|---|
| | | | Unit | 1 | 2 | 3 | 4 | 5 |
| Polypropylene-based | | (A-1) Propylene homopolymer | parts by mass | | | 28.5 | | |
| polymer (A) | | (A-2) Propylene homopolymer | parts by mass | 48.5 | 43.5 | | 48.5 | 37.5 |
| | | (A-3) Heterophasic propylene | parts by mass | | | 20.0 | | |
| Acid-modified polyolefin (D) | | polymerization material | parts by mass | 1.5 | 1.5 | 1.5 | 1.5 | 1.5 |
| Flame retardant (B) | | (B-1) Flame retardant | parts by mass | 20.0 | 25.0 | | | |
| | | (intumescent flame retardant) | | | | | | |
| | | (B-2) Flame retardant | parts by mass | | | 20.0 | 20.0 | |
| | | (intumescent flame retardant) | | | | | | |
| | | (B-3) Flame retardant | parts by mass | | | | | 31.0 |
| | | (intumescent flame retardant) | | | | | | |
| Fibers (C) | | (C-1) Glass fibers (chopped | parts by mass | 30.0 | 30.0 | 30.0 | | 30.0 |
| | | strands) | | | | | | |
| | | (C-2) Glass fibers (chopped | parts by mass | | | | 30.0 | |
| | | strands) | | | | | | |
| | | (C-3) Glass fibers (chopped | parts by mass | | | | | |
| | | strands) | | | | | | |
| | | (C-4) Glass flakes | parts by mass | | | | | |
| | | (C-5) Talc | parts by mass | | | | | |
| Evaluation | Flammability | UL94 V | — | V-0 | V-0 | V-0 | V-0 | V-0 |
| | Melt sagging | Test piece cut out in MD | mm | 4 | 3 | 6 | 3 | 3 |
| | (deformation) | Test piece cut out in TD | mm | 3 | 3 | 5 | 3 | 7 |
| | accompanying | | | | | | | |
| | combustion of test piece | | | | | | | |

TABLE 2

| | | | | Comparative example | | | | | | | | |
|---|---|---|---|---|---|---|---|---|---|---|---|---|
| | | | Unit | 1 | 2 | 3 | 4 | 5 | 6 | 7 | 8 | 9 |
| Polypropylene-based | | (A-1) | parts by | | | | | | | 72.0 | | 48.5 |
| polymer (A) | | Propylene | mass | | | | | | | | | |
| | | homopolymer | | | | | | | | | | |
| | | (A-2) | parts by | 37.5 | 43.5 | 78.5 | 68.5 | 58.5 | 48.5 | | 48.5 | |
| | | Propylene | mass | | | | | | | | | |
| | | homopolymer | | | | | | | | | | |
| | | (A-3) | parts by | | | | | | | | | |
| | | Heterophasic | mass | | | | | | | | | |
| | | propylene | | | | | | | | | | |
| | | polymerization | | | | | | | | | | |
| | | material | | | | | | | | | | |
| Acid-modified | | (D-1) Acid- | parts by | 1.5 | 1.5 | 1.5 | 1.5 | 1.5 | 1.5 | | 1.5 | 1.5 |
| polyolefin (D) | | modified | mass | | | | | | | | | |
| | | PP | | | | | | | | | | |
| Flame retardant (B) | | (B-1) | parts by | | 25.0 | | | | | 28.0 | 20.0 | 20.0 |
| | | Flame | mass | | | | | | | | | |
| | | retardant | | | | | | | | | | |
| | | (intumes- | | | | | | | | | | |
| | | cent flame | | | | | | | | | | |
| | | retardant) | | | | | | | | | | |
| | | (B-2) | parts by | | | | | | | | | |
| | | Flame | mass | | | | | | | | | |
| | | retardant | | | | | | | | | | |
| | | (intumes- | | | | | | | | | | |
| | | cent flame | | | | | | | | | | |
| | | retardant) | | | | | | | | | | |
| | | (B-3) | parts by | 31.0 | | | | | | | | |
| | | Flame | mass | | | | | | | | | |
| | | retardant | | | | | | | | | | |
| | | (intumes- | | | | | | | | | | |
| | | cent flame | | | | | | | | | | |
| | | retardant) | | | | | | | | | | |
| Fibers (C) | | (C-1) | parts by | | | 20.0 | 30.0 | 40.0 | 50.0 | | | |
| | | Glass | mass | | | | | | | | | |
| | | fibers | | | | | | | | | | |
| | | (chopped | | | | | | | | | | |
| | | strands) | | | | | | | | | | |
| | | (C-2) | parts by | | | | | | | | | |
| | | Glass | mass | | | | | | | | | |
| | | fibers | | | | | | | | | | |
| | | (chopped | | | | | | | | | | |
| | | strands) | | | | | | | | | | |
| | | (C-3) | parts by | 30.0 | 30.0 | | | | | | | |
| | | Glass | mass | | | | | | | | | |
| | | fibers | | | | | | | | | | |
| | | (chopped | | | | | | | | | | |
| | | strands) | | | | | | | | | | |
| | | (C-4) | parts by | | | | | | | | | 30.0 |
| | | Glass | mass | | | | | | | | | |
| | | flakes | | | | | | | | | | |
| | | (C-5) Talc | parts by | | | | | | | | 30.0 | |
| | | | mass | | | | | | | | | |
| Evaluation | Flammability | UL94 V | — | V-0 | V-0 | Failure | Failure | Failure | Failure | V-0 | Failure | Failure |
| | Melt | Test piece | mm | 3 | 4 | Com- | Com- | Com- | Com- | 20 | Com- | Com- |
| | sagging | cut out in | | | | pletely | pletely | pletely | pletely | | pletely | pletely |
| | (deformation) | MD | | | | burned | burned | burned | burned | | burned | burned |
| | accompanying | Test piece | mm | 13 | 11 | Comp- | Com- | Com- | Com- | 19 | Com- | Com- |
| | combustion | cut out in | | | | letely | pletely | pletely | pletely | | pletely | pletely |
| | of test piece | TD | | | | burned | burned | burned | burned | | burned | burned |

As is clear from the results shown in Tables 1 and 2, in Comparative Examples 1 and 2 in which flat fibers are not contained, even when glass fibers having a circular cross section are contained, the melt sagging accompanying the combustion of the test piece cut out in the TD is larger than the melt sagging accompanying the combustion of the test piece cut out in the MD, and the amount of deformation at a level comparable to that before deformation cannot be realized. In addition, in Comparative Examples 3 to 6 containing flat fibers but not containing a flame retardant, flame retardancy was poor, and all of the test pieces were completely burned in (Melt sagging accompanying combustion of test piece) test. In Comparative Example 7 not containing flat fibers, the amount of deformation was large when brought into contact with flame, and in Comparative Examples 8 and 9 not containing flat fibers, sufficient flame retardancy was not exhibited even when talc or glass flakes were contained, and all of the test pieces were completely burned in (Melt sagging accompanying combustion of test piece) test.

On the other hand, in Examples 1 to 5 containing a polypropylene-based polymer, a flame retardant, and a flat fiber having a ratio of a major axis to a minor axis [major axis/minor axis] in a cross section is 2.0 or more, high flame retardancy V-0 can be realized, melt sagging associated with combustion of a test piece cut out in the TD can be suppressed to a level highly comparable to that of melt sagging associated with combustion of a test piece cut out in the MD, and a molded article having a small overall amount of deformation at the time of flame contact and at a level comparable to that before deformation while exhibiting excellent flame retardancy can be realized.

1. A polypropylene-based resin composition comprising a polypropylene-based polymer (A), a flame retardant (B), and fibers (C),
wherein the fibers (C) include a fiber having a flat cross-sectional shape in which a ratio of a major axis to a minor axis [major axis/minor axis] in a cross section is 2.0 or more.

2. The polypropylene-based resin composition according to claim 1, wherein the fibers (C) are glass fibers.

3. The polypropylene-based resin composition according to claim 1, wherein the fibers (C) are glass fiber chopped strands.

4. The polypropylene-based resin composition according to claim 1, wherein a weight average fiber length of the fibers (C) is 200 to 800 m.

5. The polypropylene-based resin composition according to claim 1, wherein the flame retardant (B) includes a phosphorus-containing flame retardant.

6. The polypropylene-based resin composition according to claim 1, wherein the flame retardant (B) includes an intumescent flame retardant.

7. The polypropylene-based resin composition according to claim 1, wherein when a total amount of the polypropylene-based resin composition is 100 mass %,
a content of the polypropylene-based polymer (A) is 25 to 70 mass %,
a content of the flame retardant (B) is 5 to 50 mass %, and
a content of the fibers (C) is 5 to 50 mass %.

8. The polypropylene-based resin composition according to claim 1, further comprising an acid-modified polyolefin-based polymer (D).

9. The polypropylene-based resin composition according to claim 8, wherein when a total amount of the polypropylene-based resin composition is 100 mass %,
a content of the acid-modified polyolefin-based polymer (D) is 0.1 to 5.0 mass %.

10. A molded article comprising the polypropylene-based resin composition according to claim 1.

11. An injection molded article comprising the polypropylene-based resin composition according to claim 1.
